(19) United States
(12) Patent Application Publication
(10) Pub. No.: US 2008/0126119 A1
(43) Pub. Date: May 29, 2008

(54) SYSTEMS, METHODS AND APPARATUS FOR A NETWORK APPLICATION FRAMEWORK SYSTEM

(75) Inventors: Saad Ahmed Sirohey, Pewaukee, WI (US); Joseph M. Hogan, Chalfont St Giles (GB); Marc Barlow, Chalfont St Giles (GB); Gopal B. Avinash, New Berlin, WI (US); Tamanna N. Bembenek, Milwaukee, WI (US)

Correspondence Address: RAMIREZ & SMITH, PO BOX 341179, AUSTIN, TX, 78734, US

(73) Assignee: General Electric Company, a New York Corporation, Schenectady, NY (US)

(21) Appl. No.: 11/563,133

(22) Filed: Nov. 24, 2006

(51) Int. Cl. G06Q 50/00; G06Q 30/00

(52) U.S. Cl. 705/2; 705/14

(57) ABSTRACT

Systems, methods and apparatus are provided through which in some embodiments a central computer provides a communication path between a customer computer, a vendor computer and an expert computer. In some embodiments, a tiered fee structure that includes one or more incentive is transmitted between the computers.

### RELATED APPLICATIONS

U.S. Original application Ser. No. 11/240,609; attorney docket GE.0064, filed Sep. 29, 2005 entitled “SYSTEMS, METHODS AND APPARATUS FOR DIAGNOSIS OF DISEASE FROM CATEGORICAL INDICES” is incorporated herein by reference.

U.S. Original application Ser. No. 11/241,570; attorney docket GE.0065, filed Sep. 29, 2005 entitled “SYSTEMS, METHODS AND APPARATUS FOR TRACKING PROGRESSION AND TRACKING TREATMENT OF DISEASE FROM CATEGORICAL INDICES” is incorporated herein by reference.

U.S. Original application Ser. No. 11/240,610; attorney docket GE.0066, filed Sep. 29, 2005 entitled “SYSTEMS, METHODS AND APPARATUS FOR CREATION OF A DATABASE OF IMAGES FROM CATEGORICAL INDICES” is incorporated herein by reference.

U.S. Original application Ser. No. 11/523,878 that was filed Sep. 2, 2006 entitled “METHOD AND SYSTEM FOR AUTOMATICALLY GENERATING A DISEASE SEVERITY INDEX” is incorporated herein by reference.

This application is related to copending U.S. application Ser. No. 11/536,131 having attorney docket GE.0100 and having a filing date of Nov. 24, 2006 entitled “SYSTEMS, METHODS AND APPARATUS FOR A NETWORK APPLICATION FRAMEWORK SYSTEM.”

This application is related to copending U.S. application Ser. No. 11/______, having attorney docket GE.0111 and having a filing date of Nov. 24, 2006 entitled “SYSTEMS, METHODS AND APPARATUS FOR A NETWORK APPLICATION FRAMEWORK SYSTEM.”

This application is related to copending U.S. application Ser. No. 11/______, having attorney docket GE.0112 and having a filing date of Nov. 24, 2006 entitled “SYSTEMS, METHODS AND APPARATUS FOR A NETWORK APPLICATION FRAMEWORK SYSTEM.”

### FIELD OF THE INVENTION

This invention relates generally to image processing, and more particularly to architectures of network image processing applications.

### BACKGROUND OF THE INVENTION

In conventional network architectures of healthcare image processing, a highly decentralized architecture is implemented. In a decentralized architecture, the clients and servers of each participant in the image processing typically has the ability to directly communicate through one or more networks. This highly decentralized architecture was developed in order to reduce the transit time in communication between the clients and the servers, and also to reduce bureaucratic delays in the authorization of transfer from one client/server.

In recent years, the speed at which administrative authorization of data transfer can be obtained has improved, along with the transmission speed of data transfer. Accordingly, the need for highly decentralized architectures of image processing has decreased. Conversely, new regulations that control distribution and confidentiality of healthcare information and more complex financial requirements in healthcare financing have increased need for improving the control of data transfer from a source to a destination.

In the rapidly evolving medical imaging and post-processing applications domain, some software applications are at the cutting edge of the clinical application, in some instances, a particular software application leads and is superior to the clinical usage. However, not all software applications that interact with the cutting edge software application are state of the art. This difference in capability in interacting software applications often results in an imbalance in the cost-benefit equation from a clinical business perspective, which leads to the state-of-the art application not having the clinical impact that it would have otherwise had. For example, remote review and storage providers can alleviate the expense of a large picture archive communication (PACS) installation. However this has not been the case for advanced post processing applications. The reduced clinical impact of some software applications is more acute in the case of new software applications where the users may not be interested in a large financial commitment for low current procedure volumes.

From the business side, an application is often ready to be implemented in production, but yet at the same time the application is not approved for production use because the application lacks clinical prove out and in cases the application may need additional clinical databases. Some applications that need knowledgebase or reference databases, inherently, are best suited if there is a continual renewal of the knowledgebase or the reference databases. Accessing such data from the data generating sites is non-trivial in terms of logistical and transactional complexities.

Conventional systems provide partnership with healthcare experts through a clinical evaluation phase that includes clinical evaluation and or testing prior to production sales, which provide no additional guidance if customers so require. However, the partnership with experts tends to be limited and not very broad based, which limits the value that healthcare experts can provide.

For the reasons stated above, and for other reasons stated below which will become apparent to those skilled in the art upon reading and understanding the present specification, there is a need in the art for less decentralized control, distribution and transmission of data in image processing applications. There is also a need to improve access of clinical databases from the data generating sites. There is also a need to partner with leading luminary medical experts to obtain expert advice and provide guidance to the larger medical community.

### BRIEF DESCRIPTION OF THE INVENTION

The above-mentioned shortcomings, disadvantages and problems are addressed herein, which will be understood by reading and studying the following specification.

Systems, methods and apparatus of a web-based structured healthcare application is described herein.

In one aspect, a network application framework system provides a centralized collaboration between a healthcare vendor, a healthcare customer and a healthcare expert.

In another aspect, a set of web-based computers includes one or more client(s) and one or more server(s), the servers including one or more healthcare image processing applications, in which a data structure that identifies a tiered fee structure and one or more incentive is included in one or more of the server(s) and the one or more client(s).

In yet another aspect, a method of healthcare image processing performed by a first processor, in which the method includes sending healthcare image data to a second processor without reference to an initiation command received from a human operator or the first processor, sending to the second processor, service-order requisition data in reference to an account status of the customer describing a first level of service by the second processor, receiving from the second processor, an indication of availability of data at the second processor, sending to the second processor, the initiation command for processing data, receiving from the second processor, results of the service-order based structured processing applications on the healthcare image data by the second processor, creating a report in reference to the healthcare image data and in reference to the results and receiving from the second processor, an invoice in accordance with the first level of service.

In still another aspect, a system that supports collaboration between a customer and a healthcare expert in which the system includes a secure server component that is operable to moderate an exchange between the customer and the healthcare expert using a structured processing application component, a secure-communication component that is operable to communicate with the customer and the healthcare expert, and a collaborative component operable to exchange data between the customer and the healthcare expert through the secure-communication component, the exchange consisting essentially of between the customer and the healthcare expert.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to provide a centralized communication path and healthcare image processing applications to a vendor, an expert and a customer;

FIG. 2 is a flowchart of a method to support collaboration between a customer, a healthcare vendor and a healthcare-expert, according to an embodiment;

FIG. 3 is a flowchart of a method performed in addition to the method in FIG. 2, according to an embodiment;

FIG. 4 is a flowchart of a method to support collaboration between a customer, a healthcare vendor and a healthcare-expert, according to an embodiment;

FIG. 5 is a flowchart of a method to support collaboration between a customer, a healthcare vendor and a healthcare-expert, according to an embodiment;

FIG. 6 is a flowchart of a method to support communication between a customer, a healthcare vendor and a healthcare-expert, according to an embodiment;

FIG. 7 is a flowchart of a method of healthcare image processing performed by a healthcare image processor, according to an embodiment;

FIG. 8 is a flowchart of a method of healthcare image processing performed by a first processor, according to an embodiment;

FIG. 9 is a flowchart of a method of healthcare image processing performed by a first processor according to an embodiment;

FIG. 10 is a flowchart of a method of healthcare image processing performed by a first processor, according to an embodiment;

FIG. 11 is a flowchart of a method of healthcare image processing performed by a first processor, according to an embodiment;

FIG. 12 is a flowchart of a method of healthcare image processing performed by a first processor, according to an embodiment;

FIG. 13 is a block diagram of a hardware and operating environment in which different embodiments can be practiced;

FIG. 14 is a block diagram of an apparatus to provide centralized communication and healthcare image processing applications to expert(s) and a customer;

FIG. 15 is a block diagram of an application service provider system, according to an embodiment;

FIG. 16 is a diagram of a transactional data structure, according to an embodiment;

FIG. 17 is a block diagram of customer site of a network application framework system, according to an embodiment;

FIG. 18 is a block diagram of a server of a network application framework system, according to an embodiment;

FIG. 19 is a block diagram of a client and server of a network application framework system, according to an embodiment;

FIG. 20 is a block diagram of a client in a network application framework system, according to an embodiment;

FIG. 21 is a block diagram of a server of a network application framework system, according to an embodiment;

FIG. 22 is a block diagram of a client and server of a network application framework system, according to an embodiment;

FIG. 23 is a block diagram of customer site of a network application framework system, according to an embodiment;

FIG. 24 is a block diagram of a server of a network application framework system, according to an embodiment;

FIG. 25 is a block diagram of expert site of a network application framework system, according to an embodiment;

FIG. 26 is a block diagram of a client and server of a network application framework system, according to an embodiment;

FIG. 27 is a block diagram of a system that supports collaboration between a customer and a healthcare expert, according to an embodiment;

FIG. 28 is a block diagram of a system that supports collaboration between a customer and a healthcare expert, according to an embodiment;

FIG. 29 is a block diagram of a web-based plurality of operably coupled computers to provide centralized communication and healthcare image processing applications between a client and server;

FIG. 30 is a block diagram of a web-based plurality of operably coupled computers to provide centralized communication and healthcare image processing applications between a client and server; and

FIG. 31 is a block diagram of an application service provider system, according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, a system level overview is described. In the second section, embodiments of methods are described. In the third section, a hardware and the operating environment in conjunction with which embodiments may be practiced are described. In the fourth section, particular implementations are described. Finally, in the fifth section, a conclusion of the detailed description is provided.

### System Level Overview

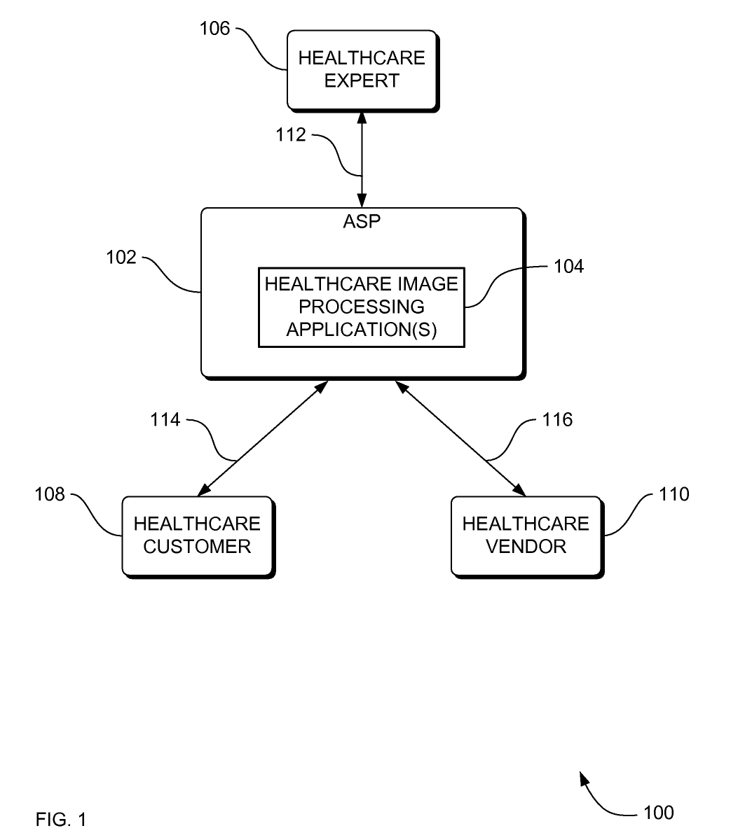

FIG. 1 is a block diagram of an overview of a system to provide a centralized communication path and healthcare image processing applications to a vendor, an expert and a customer. System 100 solves the need in the art for more centralized control, distribution and transmission of data in healthcare image processing applications.

System 100 includes an application-service provider (ASP) 102 that hosts one or more healthcare image processing application(s) 104. In general, an application service provider is a business entity providing infrastructure to run an application as a service. The ASP 102 is accessible to and interacts with, a healthcare expert 106, a healthcare customer 108 and a healthcare vendor 110. The medium(s) of communication (112, 114 and 116) between the ASP 102 and the healthcare expert 106, the healthcare customer 108 and the healthcare vendor 110 is one or more network(s), although one embodiment of the communication medium(s) is the Internet.

The ASP 102 that is operably coupled to the healthcare expert 106, a healthcare customer 108 and a healthcare vendor 110 provides a common source for the one or more healthcare imaging processing application(s) 104. The ASP 102, as a common source for healthcare imaging processing applications, solves the need in the art for more centralized control, distribution and transmission of data in healthcare image processing applications.

One example of the healthcare image processing application 104 is a neuro-degenerative disease severity indexing application that references a disease severity knowledgebase, such as described in U.S. Original application Ser. No. 11/240609, U.S. Original application Ser. No. 11/241570, and U.S. Original application Ser. No. 11/240610.

While the system 100 is not limited to any particular ASP 102, healthcare image processing application(s) 104, healthcare expert 106, healthcare customer 108, healthcare vendor 110, for sake of clarity simplified ASP 102, healthcare image processing application(s) 104, healthcare expert 106, healthcare customer 108, healthcare vendor 110 are described.

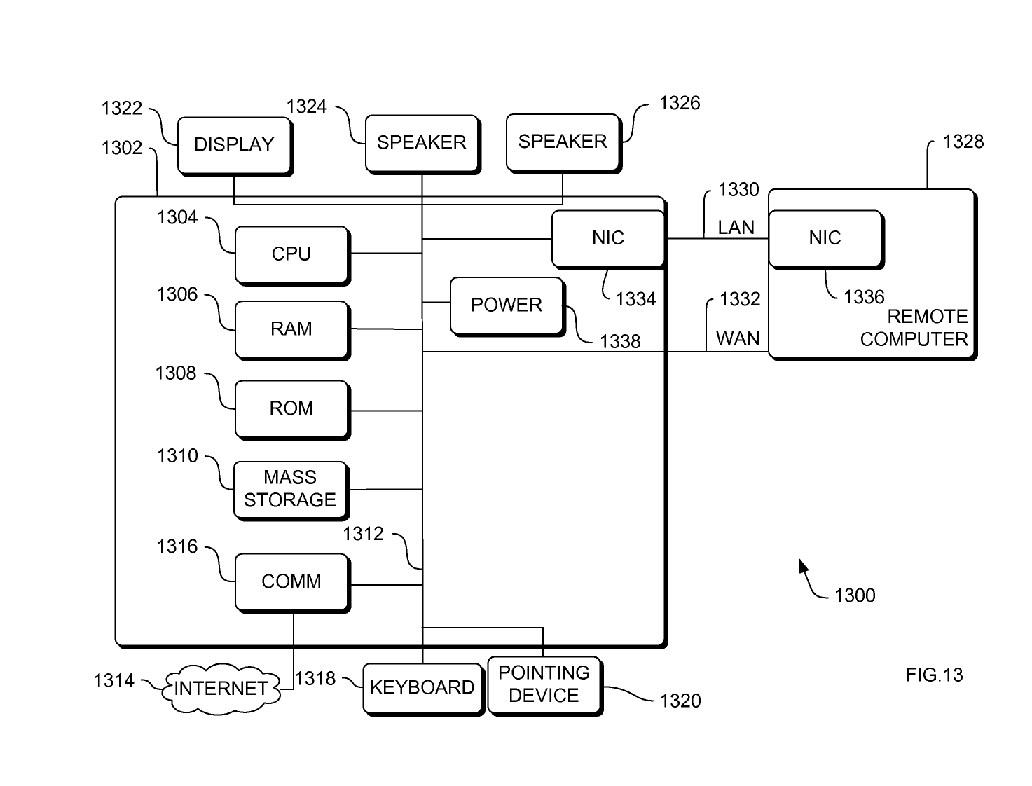

The system level overview of the operation of an embodiment is described above in this section of the detailed description. Some embodiments operate in a multi-processing, multi-threaded operating environment on a computer, such as computer 1302 in FIG. 13.

### Method Embodiments

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-1200 are performed by a program executing on, or performed by firmware or hardware that is a part of, a computer, such as computer 1302 in FIG. 13.

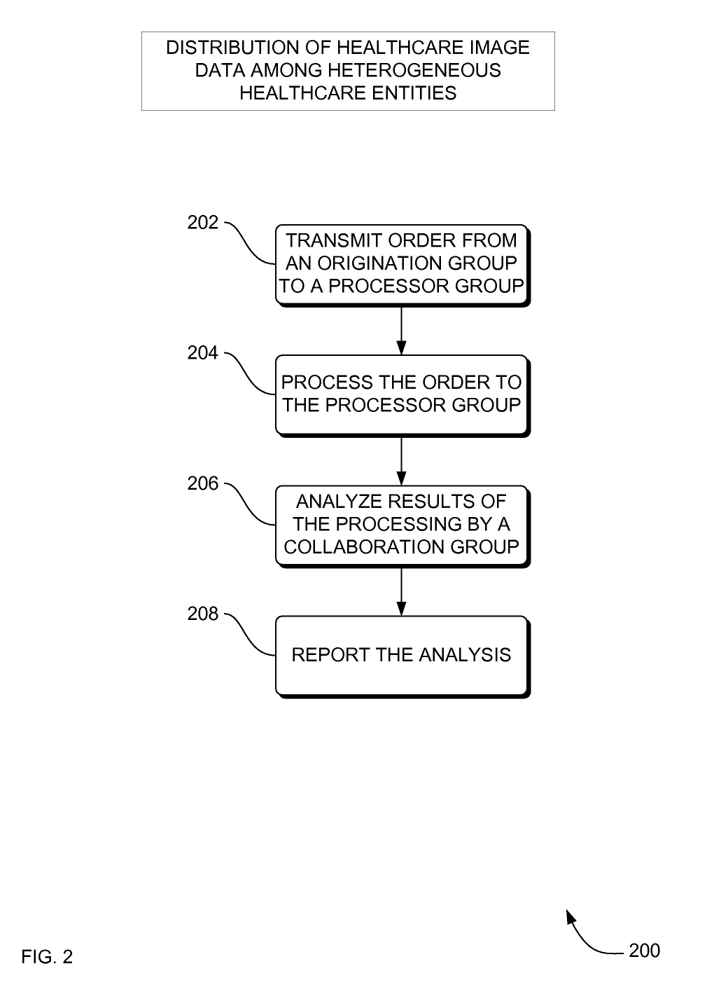

FIGS. 2-4 describe methods of performing healthcare image processing in a distributed network in which the image is sourced from one member of a particular group, processed by a member of another group, analyzed by a member of another group and reported to member(s) of another. The groups can include a healthcare vendor, a healthcare expert and a health customer. The methods can include tiered fee structures and incentives to the customer for providing data and services related to the image processing. FIGS. 2-4 describe applications processing and distribution of healthcare image data among heterogeneous healthcare entities that solves the need in the art for less decentralized control, distribution and transmission of data in image processing applications which in turn supports and encourages the widespread adoption and implementation healthcare image processing applications and services.

FIG. 2 is a flowchart of a method 200 to support collaboration between a customer, a healthcare vendor and a healthcare-expert, according to an embodiment. Some embodiment of method 200 includes transmitting 202 an order from an entity in an origination group to an entity in a processing group. In some embodiments of method 200, the order is embodied as an order-requisition-form, the origination group includes a human and a computer and the processing group includes a human, a computer, a human technician and a human expert, which case the transmitting 202 includes transmitting an order-requisition-form to an entity selected from a group consisting of a human, a computer, a human technician and a human expert and the sending is performed by an entity selected from a group consisting of the human and the computer.

Some embodiments of method 200 include processing 204 a healthcare image application in accordance with the order in which the processing is performed by an entity in the processing group. In some embodiments of the processing 204 in which the order is embodied as the order-requisition-form and the processing group includes a human, a computer, a human technician and a human expert, which case the processing 204 includes processing 204 includes processing the healthcare image application in accordance with the order-requisition-form, the processing being performed by the entity selected from the group consisting of the human, the computer, the human technician and the human expert.

Some embodiments of method 200 include analyzing 206 results of the processing of the healthcare image application in action 204 in accordance with the order. The analyzing 206 is performed by an entity in a collaboration group. In some embodiments the collaboration group includes a human, a computer, a human expert and a human collaborator, in which case the analyzing 206 includes analyzing results of the processing of the healthcare image application in accordance with the order-requisition-form and the analyzing is performed by an entity selected from a group consisting of the human, the computer, the human expert and a human collaborator.

Some embodiments of method 200 include reporting 208 results of the analyzing in action 206. The reporting is performed by the entity in the collaboration group, in which case the reporting 208 includes reporting results of the analyzing 206, the reporting is performed by the entity selected from the group consisting of the human, the computer, the human expert and the human collaborator.

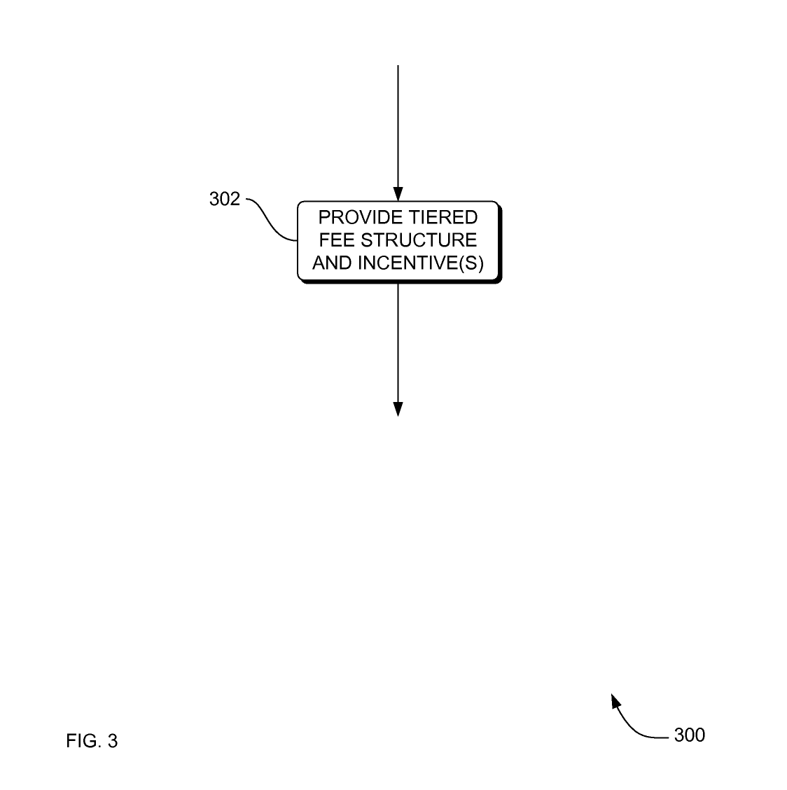

FIG. 3 is a flowchart of a method 300 performed in addition to method 200, according to an embodiment.

Method 300 includes providing 302 a tiered fee structure to a customer that includes one or more incentive(s). In some embodiments, the tiered fee structure and the one or more incentive(s) includes a plurality of billing discounts in which each of the billing discounts is associated with one of a plurality of customer services.

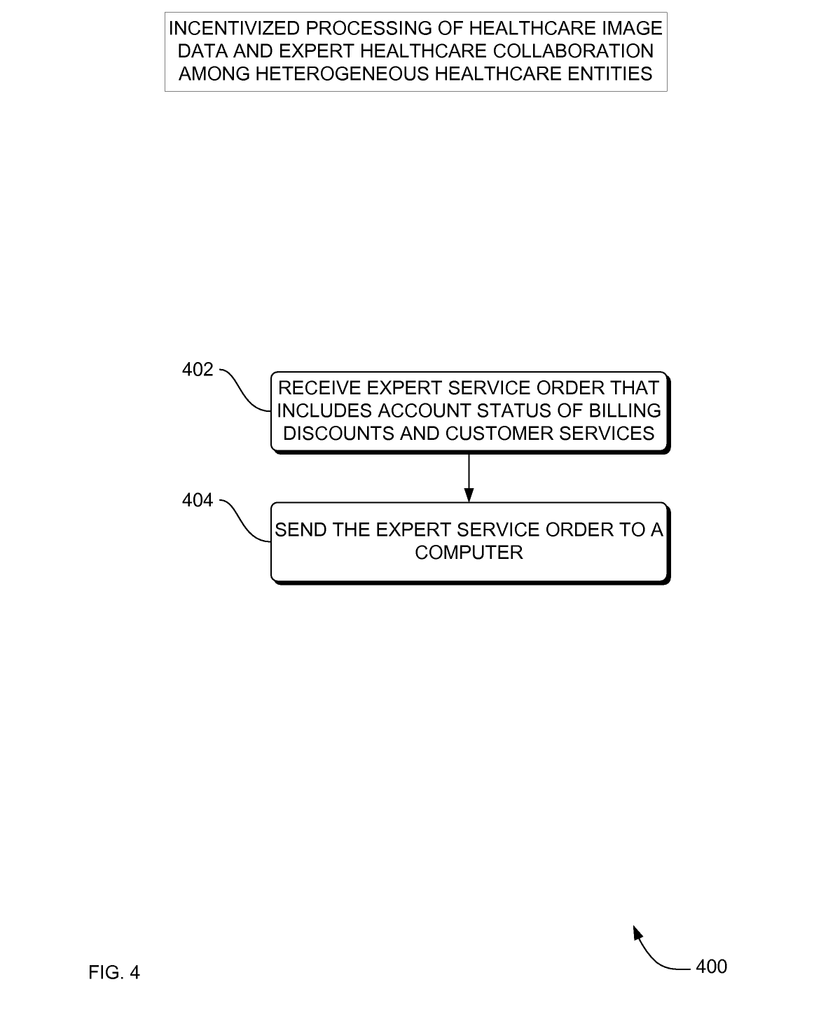

FIG. 4 is a flowchart of a method 400 to support collaboration between a customer, a healthcare vendor and a healthcare-expert, according to an embodiment. Method 400 solves the need in the art to partner leading luminary medical experts to obtain expert advice and provide guidance to the larger medical community.

Some embodiments of method 400 include receiving 402 healthcare-expert service-order requisition data in reference to an account status of the customer. The account status includes a plurality of billing discounts and a plurality of customer services that in some embodiments includes: a first billing discount (such as a 10% billing discount) that is associated with a customer service of providing image data; a second billing discount (such as a 20% billing discount) that associated with a customer service of providing image data and a clinical outcome; a third billing discount (such as a 50% billing discount) associated with a customer service of providing consultancy on clinical image analysis. In some embodiments of method 400, the receiving 402 is performed through a graphical user interface.

Some embodiments of method 400 include sending the healthcare-expert service-order requisition data to a computer. In one example of method 400, the healthcare-expert service-order requisition data is transmitted by a health-customer 108 in FIG. 1 and received 402 by the ASP 102, then the healthcare-expert service-order requisition data is transmitted from the ASP 102 to the healthcare expert 106 and/or the healthcare vendor 110.

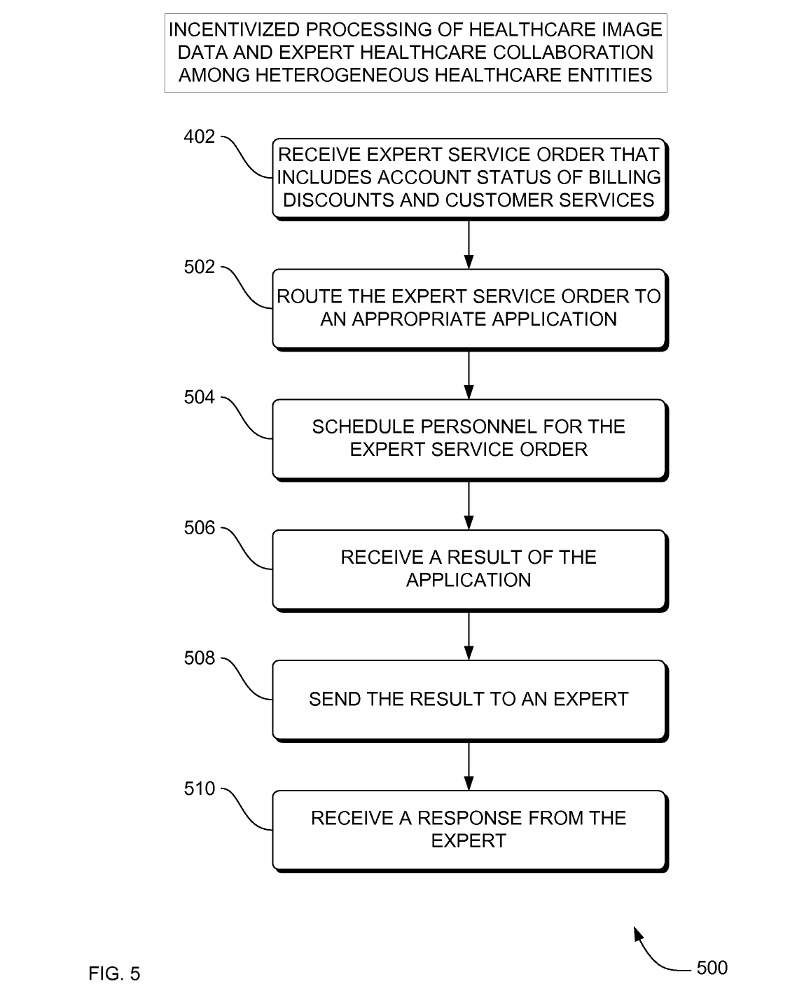

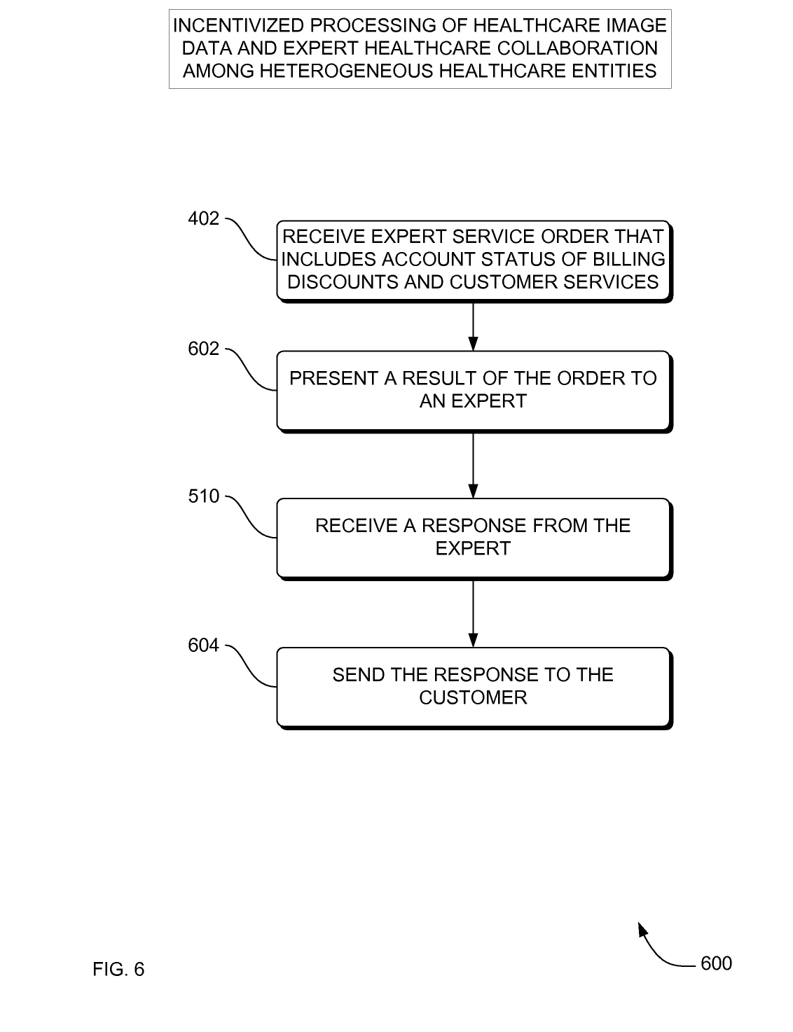

FIGS. 5-6 describe methods of collaboration and communication between a healthcare customer, a healthcare vendor and a healthcare-expert that is encouraged by billing discounts. The methods in FIGS. 5-6 help improve partnership and collaboration of healthcare experts to the larger medical community in the incentivized processing of healthcare image data and expert healthcare collaboration among heterogeneous healthcare entities.

FIG. 5 is a flowchart of a method 500 to support collaboration between a customer, a healthcare vendor and a healthcare-expert, according to an embodiment. The service(s) provided by method 500 can be described as providing a high-level “ultimate” level of service.

Some embodiments of method 500 include receiving 402 healthcare-expert service-order requisition data in reference to an account status of the customer. Similar to method 400 above, the account status includes a plurality of billing discounts and a plurality of customer services.

Some embodiments of method 500 include routing 502 the healthcare-expert service-order requisition data to an appropriate healthcare application. One example of the appropriate healthcare application is the healthcare image processing application 104, such as the neuro-degenerative disease severity indexing application that references a disease severity knowledgebase.

Some embodiments of method 500 include scheduling 504 personnel in reference to the healthcare-expert service-order requisition data.

Some embodiments of method 500 include receiving 506 a result from the appropriate healthcare application. Some embodiments of method 500 include sending 508 the result to the healthcare-expert. Some embodiments of method 500 include receiving 510 a response from the healthcare-expert.

FIG. 6 is a flowchart of a method 600 to support communication between a customer, a healthcare vendor and a healthcare-expert, according to an embodiment.

Some embodiments of method 600 include receiving 402 an order with data from a customer regarding healthcare-expert service-order requisition. Some embodiments of method 600 include presenting 602 a result of the order to the healthcare-expert. Some embodiments of method 600 include receiving 510 a response from the healthcare-expert. Some embodiments of method 600 include sending 604 the response to the customer.

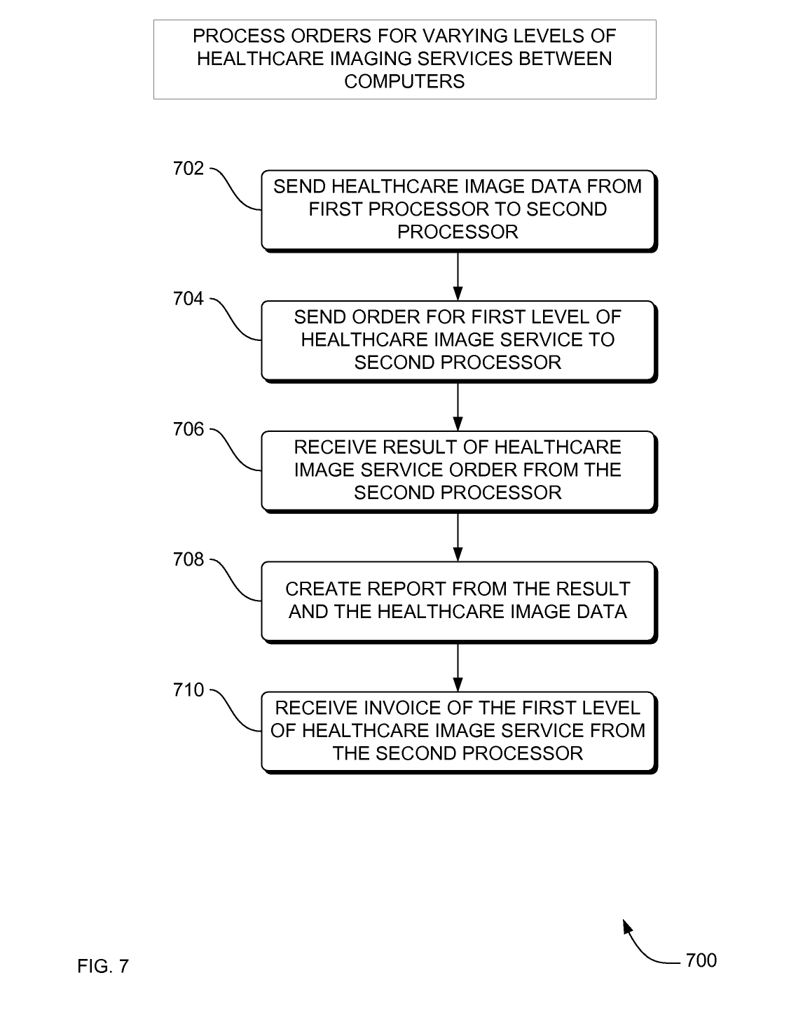

FIGS. 7-12 describe methods of processing orders for healthcare image services between a first computer, which is typically operated by a customer, and a second computer, in which the order is processed with varying levels of service from basic image processing to higher levels of service that could include expert image analysis and collaboration in the image analysis. Thus FIGS. 7-12 provide partnership with leading luminary medical experts to obtain expert advice and provide guidance to the larger medical community

FIG. 7 is a flowchart of a method 700 of healthcare image processing performed by a healthcare image processor, according to an embodiment.

Some embodiments of method 700 include sending 702 healthcare image data to a second processor in reference to an initiation command. The initiation command is received by the second processor beforehand by the second processor from a human operator or the initiation command is received beforehand by the second processor by the first processor.

Some embodiments of method 700 include sending 704 to the second processor, service-order requisition data in reference to an account status of the customer describing a first (e.g. a “regular” standard) level of service by the second processor.

Some embodiments of method 700 include receiving 706 from the second processor, results of service-order based structured processing applications on the healthcare image data by the second processor. One example of the structured processing applications is the healthcare image processing application 104, such as the neuro-degenerative disease severity indexing application that references a disease severity knowledgebase.

Some embodiments of method 700 include creating 708 a report in reference to the healthcare image data and in reference to the results.

Some embodiments of method 700 include receiving 710 from the second processor, an invoice in accordance with the first level of service.

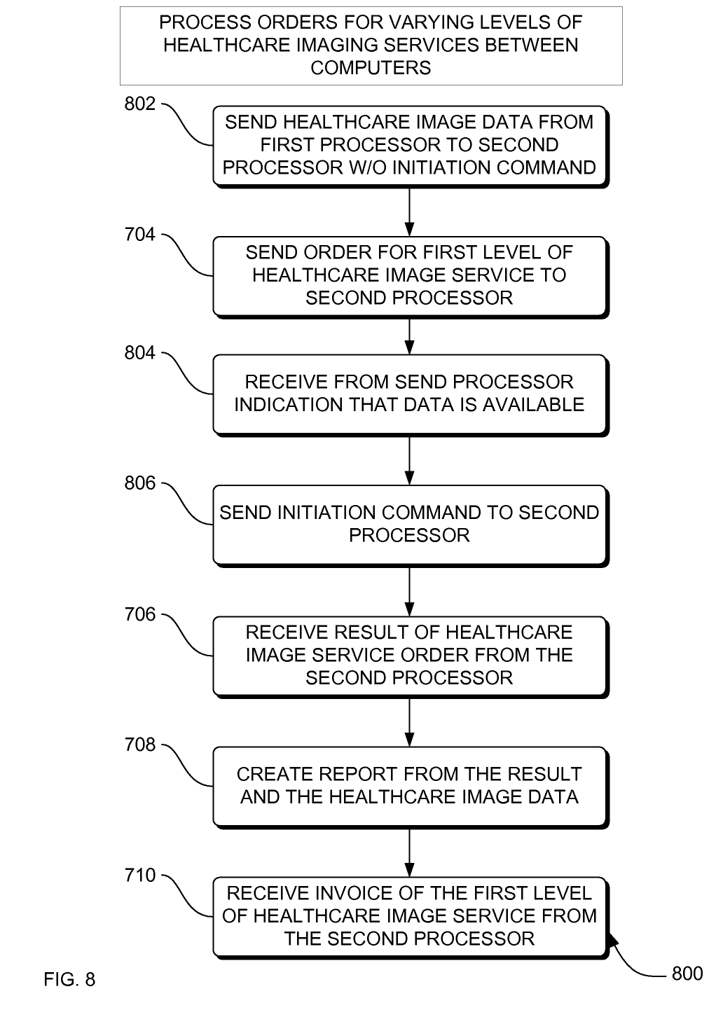

FIG. 8 is a flowchart of a method 800 of healthcare image processing performed by a first processor, according to an embodiment.

Some embodiments of method 800 include sending 802 healthcare image data to a second processor without reference to an initiation command received from a human operator or the first processor.

Some embodiments of method 800 include sending 704 to the second processor, service-order requisition data in reference to an account status of the customer describing a first (e.g. “regular”) level of service by the second processor.

Some embodiments of method 800 include receiving 804 from the second processor, an indication of availability of data at the second processor.

Some embodiments of method 800 include sending 806 to the second processor, the initiation command for processing data.

Some embodiments of method 800 include receiving 706 from the second processor, results of the service-order based structured processing applications on the healthcare image data by the second processor. One example of the structured processing applications is the healthcare image processing application 104, such as the neuro-degenerative disease severity indexing application that references a disease severity knowledgebase.

Some embodiments of method 800 include creating 708 a report in reference to the healthcare image data and in reference to the results. Some embodiments of method 800 include receiving 710 from the second processor, an invoice in accordance with the first (e.g. a “regular” standard) level of service.

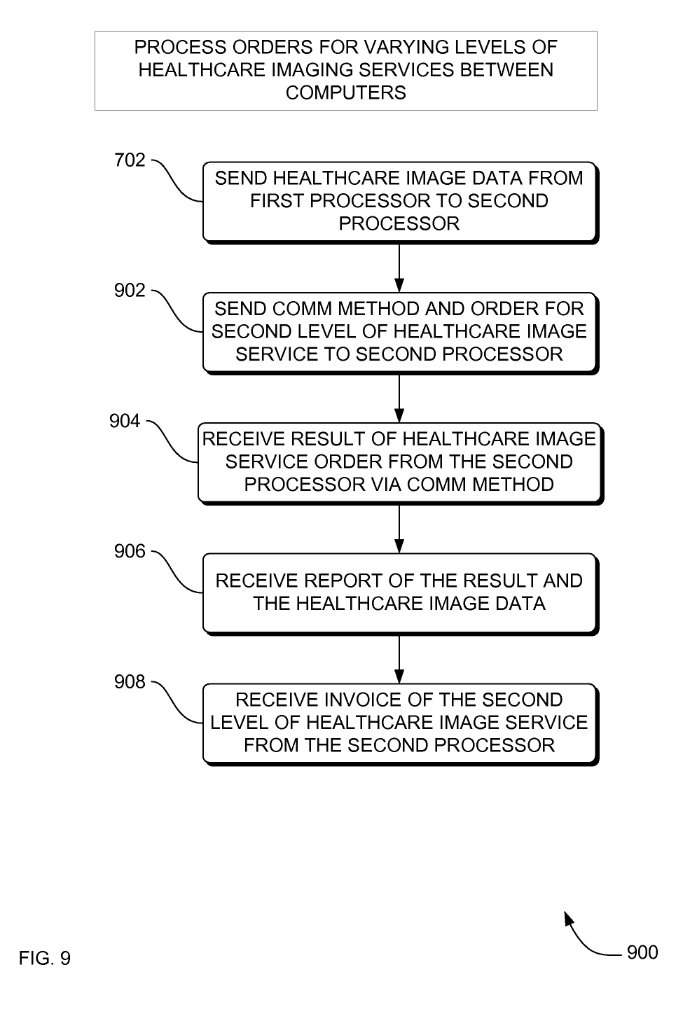

FIG. 9 is a flowchart of a method 900 of healthcare image processing performed by a first processor according to an embodiment. Some embodiments of method 900 include sending 702 healthcare image data to a second processor.

Some embodiments of method 900 include sending 902 to the second processor, a service-order requisition data in reference to an account status of the customer describing a second (e.g. a “deluxe”) level of service by the second processor, and selecting a method of communication for results. In some embodiments, the method of communication includes email, data encoded according to digital imaging and communications in medicine (DICOM) structured reporting (SR), fax, page, and WiFi to wireless. DICOM conforms to the International Organization for Standardization (ISO) reference model for network communications. The DICOM standard was developed jointly by the National Equipment Manufacturers Association (NEMA) in Rosslyn, Va. and by the American College of Radiology (ACR). DICOM is published by NEMA. The DICOM standard is also known as the ACR/NEMA standard.

Some embodiments of method 900 include receiving 904 from the second processor through the selected method of communication, results of service-order based automated structured processing applications on the healthcare image data by the second processor. One example of the structured automated processing applications is the healthcare image processing application 104, such as the neuro-degenerative disease severity indexing application that references a disease severity knowledgebase.

Some embodiments of method 900 include receiving 906 from the second processor through the method of communication, a report in reference to the healthcare image data and in reference to the results.

Some embodiments of method 900 include receiving 908 from the second processor, an invoice in accordance with the second level of service.

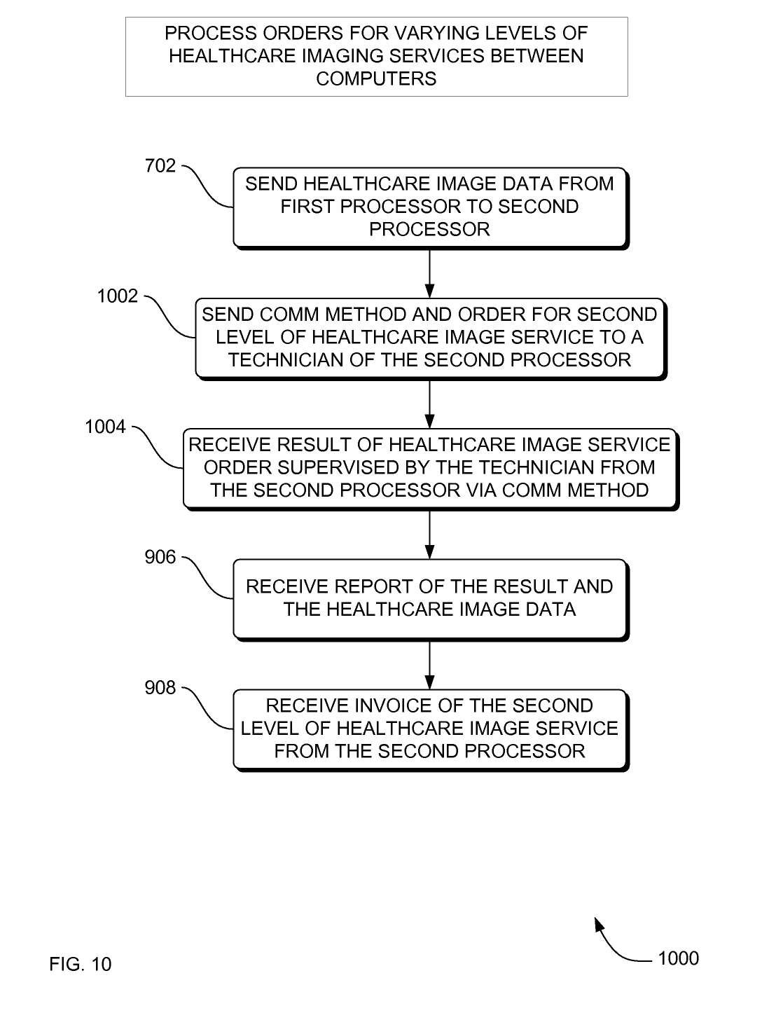

FIG. 10 is a flowchart of a method 1000 of healthcare image processing performed by a first processor, according to an embodiment.

Some embodiments of method 1000 include sending 702 healthcare image data to a second processor.

Some embodiments of method 1000 include sending 1002 to the second processor, a service-order requisition data in reference to an account status of the customer describing a second (e.g. “deluxe”) level of service by the second processor that requires technician supervision of processing by the second processor, and selecting a method of communication for results. In some embodiments, the method of communication includes email, DICOM SR, fax, page, and WiFi to wireless.

Some embodiments of method 1000 include receiving 1004 from the second processor through the selected method of communication, results of service-order based automated structured processing applications supervised by the technician on the healthcare image data by the second processor. One example of the structured automated processing applications is the healthcare image processing application 104, such as the neuro-degenerative disease severity indexing application that references a disease severity knowledgebase.

Some embodiments of method 1000 include receiving 906 from the second processor through the method of communication, a report in reference to the healthcare image data and in reference to the results.

Some embodiments of method 1000 include receiving 908 from the second processor, an invoice in accordance with the second level of service.

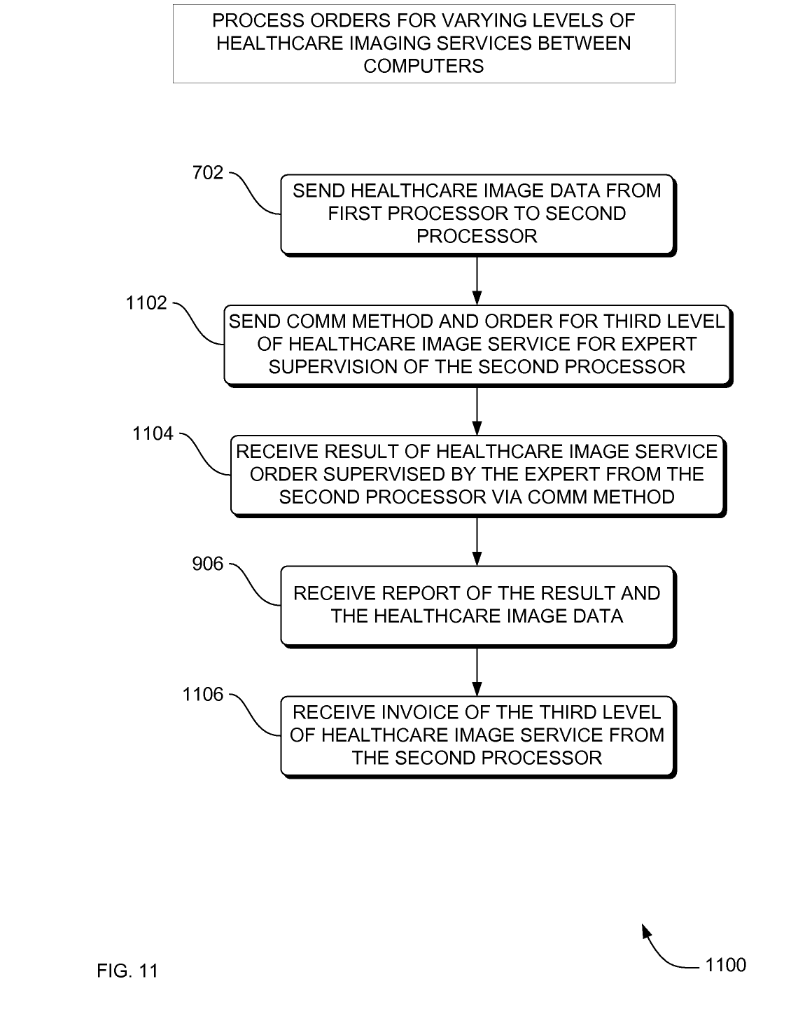

FIG. 11 is a flowchart of a method 1100 of healthcare image processing performed by a first processor, according to an embodiment.

Some embodiments of method 1100 include sending 702 healthcare image data to a second processor.

Some embodiments of method 1100 include sending 1102 to the second processor, a service-order requisition data in reference to an account status of the customer describing a third (e.g. a “premium”) level of service by the second processor that requires expert supervision of processing by the second processor, and selecting a method of communication for results. In some embodiments, the method of communication includes email, DICOM SR, fax, page, and WiFi to wireless.

Some embodiments of method 1100 include receiving 1104 from the second processor through the selected method of communication, results of service-order based automated structured processing applications supervised by the expert on the healthcare image data by the second processor. One example of the structured automated processing applications is the healthcare image processing application 104, such as the neuro-degenerative disease severity indexing application that references a disease severity knowledgebase.

Some embodiments of method 1100 include receiving 906 from the second processor through the method of communication, a report in reference to the healthcare image data and in reference to the results.

Some embodiments of method 1100 include receiving 1106 from the second processor, an invoice in accordance with the third level of service.

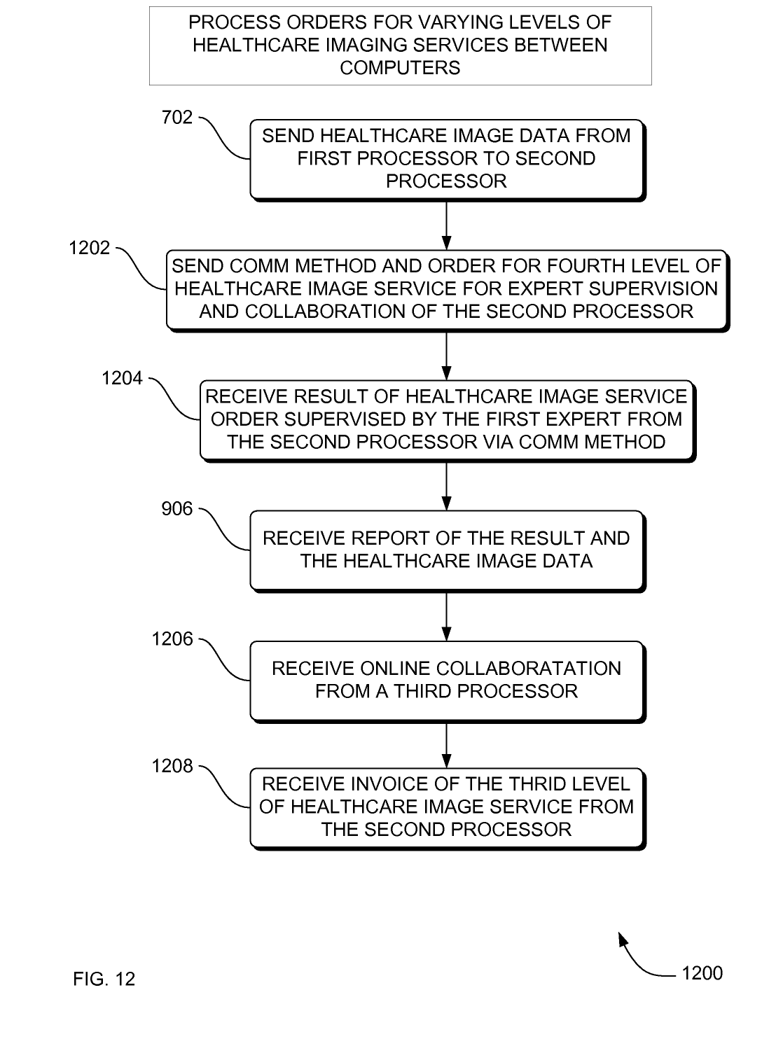

FIG. 12 is a flowchart of a method 1200 of healthcare image processing performed by a first processor, according to an embodiment.

Some embodiments of method 1200 include sending 702 healthcare image data to a second processor.

Some embodiments of method 1200 include sending 1202 to the second processor, a service-order requisition data in reference to an account status of the customer describing a fourth (e.g. a “ultimate”) level of service by the second processor that requires expert supervision and a second expert collaboration of processing by the second processor, and selecting a method of communication for results. In some embodiments, the method of communication includes email, DICOM SR, fax, page, and WiFi to wireless.

Some embodiments of method 1200 include receiving 1204 from the second processor through the selected method of communication, results of service-order based automated structured processing applications supervised by the first expert on the healthcare image data by the second processor. One example of the structured automated processing applications is the healthcare image processing application 104, such as the neuro-degenerative disease severity indexing application that references a disease severity knowledgebase.

Some embodiments of method 1200 include receiving 906 from the second processor through the method of communication, a report in reference to the healthcare image data and in reference to the results.

Some embodiments of method 1200 include receiving 1206 from the second processor an on-line collaboration with the second expert through a third processor.

Some embodiments of method 1200 include receiving 1208 from the second processor, an invoice in accordance with the fourth level of service. The invoice describes the third processor and the fist and second expert and their roles and differences.

In some embodiments, methods 200-1200 are implemented as a computer data signal embodied in a carrier wave, that represents a sequence of instructions which, when executed by a processor, such as processor 1304 in FIG. 13, cause the processor to perform the respective method. In other embodiments, methods 200-1200 are implemented as a computer-accessible medium having executable instructions capable of directing a processor, such as processor 1304 in FIG. 13, to perform the respective method. In varying embodiments, the medium is a magnetic medium, an electronic medium, or an optical medium.

### Hardware and Operating Environment

FIG. 13 is a block diagram of a hardware and operating environment 1300 in which different embodiments can be practiced. The description of FIG. 13 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 1302 includes a processor 1304, commercially available from Intel, Motorola, Cyrix and others. Computer 1302 also includes random-access memory (RAM) 1306, read-only memory (ROM) 1308, and one or more mass storage devices 1310, and a system bus 1312, that operatively couples various system components to the processing unit 1304. The memory 1306, 1308, and mass storage devices, 1310, are types of computer-accessible media. Mass storage devices 1310 are more specifically types of nonvolatile computer-accessible media and can include one or more hard disk drives, floppy disk drives, optical disk drives, and tape cartridge drives. The processor 1304 executes computer programs stored on the computer-accessible media.

Computer 1302 can be communicatively connected to the Internet 1314 via a communication device 1316. Internet 1314 connectivity is well known within the art. In one embodiment, a communication device 1316 is a modem that responds to communication drivers to connect to the Internet via what is known in the art as a “dial-up connection.” In another embodiment, a communication device 1316 is an Ethernet® or similar hardware network card connected to a local-area network (LAN) that itself is connected to the Internet via what is known in the art as a “direct connection” (e.g., T1 line, etc.).

A user enters commands and information into the computer 1302 through input devices such as a keyboard 1318 or a pointing device 1320. The keyboard 1318 permits entry of textual information into computer 1302, as known within the art, and embodiments are not limited to any particular type of keyboard. Pointing device 1320 permits the control of the screen pointer provided by a graphical user interface (GUI) of operating systems such as versions of Microsoft Windows®. Embodiments are not limited to any particular pointing device 1320. Such pointing devices include mice, touch pads, trackballs, remote controls and point sticks. Other input devices (not shown) can include a microphone, joystick, game pad, satellite dish, scanner, or the like.

In some embodiments, computer 1302 is operatively coupled to a display device 1322. Display device 1322 is connected to the system bus 1312. Display device 1322 permits the display of information, including computer, video and other information, for viewing by a user of the computer. Embodiments are not limited to any particular display device 1322. Such display devices include cathode ray tube (CRT) displays (monitors), as well as flat panel displays such as liquid crystal displays (LCD's). In addition to a monitor, computers typically include other peripheral input/output devices such as printers (not shown). Speakers 1324 and 1326 provide audio output of signals. Speakers 1324 and 1326 are also connected to the system bus 1312.

Computer 1302 also includes an operating system (not shown) that is stored on the computer-accessible media RAM 1306, ROM 1308, and mass storage device 1310, and is executed by the processor 1304. Examples of operating systems include Microsoft Windows®, Apple MacOS®, Linux®, UNIX®. Examples are not limited to any particular operating system, however, and the construction and use of such operating systems are well known within the art.

Embodiments of computer 1302 are not limited to any type of computer 1302. In varying embodiments, computer 1302 comprises a PC-compatible computer, a MacOS®-compatible computer, a Linux®-compatible computer, or a UNIX®-compatible computer. The construction and operation of such computers are well known within the art.

Computer 1302 can be operated using at least one operating system to provide a graphical user interface (GUI) including a user-controllable pointer. Computer 1302 can have at least one web browser application program executing within at least one operating system, to permit users of computer 1302 to access an intranet, extranet or Internet world-wide-web pages as addressed by Universal Resource Locator (URL) addresses. Examples of browser application programs include Netscape Navigator® and Microsoft Internet Explorer®.

The computer 1302 can operate in a networked environment using logical connections to one or more remote computers, such as remote computer 1328. These logical connections are achieved by a communication device coupled to, or a part of, the computer 1302. Embodiments are not limited to a particular type of communications device. The remote computer 1328 can be another computer, a server, a router, a network PC, a client, a peer device or other common network node. The logical connections depicted in FIG. 13 include a local-area network (LAN) 1330 and a wide-area network (WAN) 1332. Such networking environments are commonplace in offices, enterprise-wide computer networks, intranets, extranets and the Internet.

When used in a LAN-networking environment, the computer 1302 and remote computer 1328 are connected to the local network 1330 through network interfaces or adapters 1334, which is one type of communications device 1316. Remote computer 1328 also includes a network device 1336. When used in a conventional WAN-networking environment, the computer 1302 and remote computer 1328 communicate with a WAN 1332 through modems (not shown). The modem, which can be internal or external, is connected to the system bus 1312. In a networked environment, program modules depicted relative to the computer 1302, or portions thereof, can be stored in the remote computer 1328.

Computer 1302 also includes power supply 1338. Each power supply can be a battery.

### Apparatus Implementations

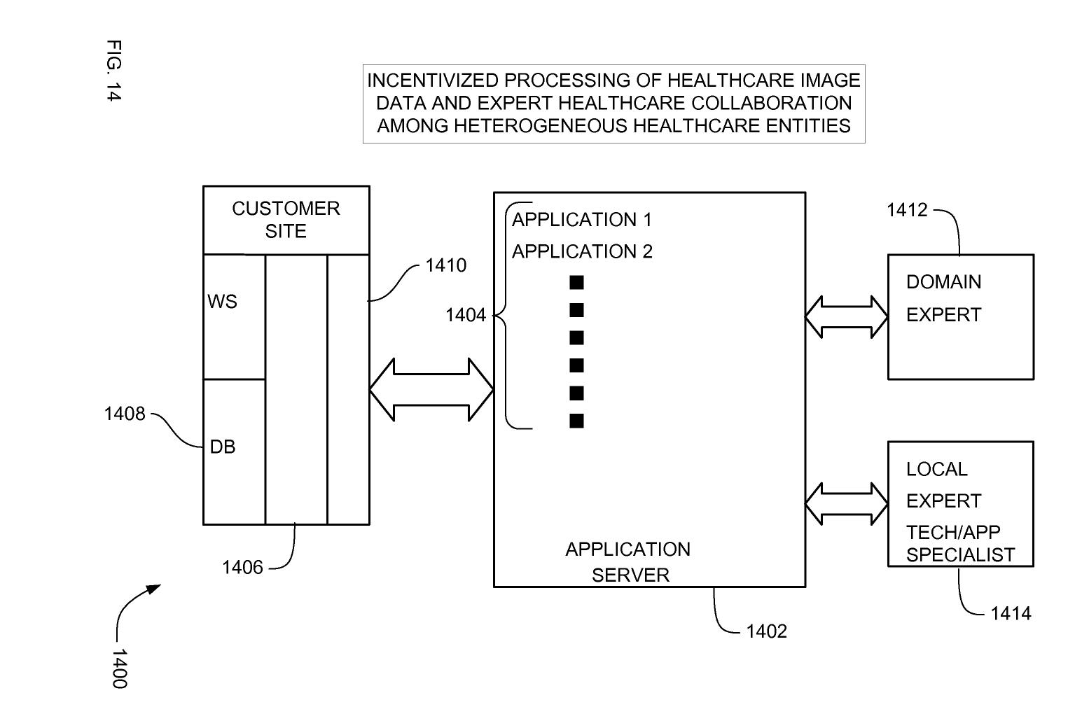

Referring to FIGS. 14-31, particular implementations are described in conjunction with the system overview in FIG. 1 and the methods described in conjunction with FIGS. 2-12. FIGS. 14-31 describe a distributed system of healthcare image processing between a healthcare customer, a healthcare-expert and/or a healthcare vendor that is encouraged by billing discounts.

FIG. 14 is a block diagram of an apparatus 1400 to provide centralized communication and healthcare image processing applications to expert(s) and a customer. Apparatus 1400 is substantially similar to the system of FIG. 1. FIG. 14 describes efficacious applications processing and distribution of healthcare image data among heterogeneous healthcare entities through an healthcare imaging application that solves the need in the art for less decentralized control, distribution and transmission of data in image processing applications which in turn supports and encourages the widespread adoption and implementation healthcare image processing applications and services. FIG. 14 also describes an apparatus that provides improved access of clinical databases from the data generating sites and that provide partnering with leading luminary medical experts to obtain expert advice and provide guidance to the larger medical community.

Apparatus 1400 includes an application server 1402. In general, a server is a computational infrastructure for serving multiple computers that may be local or distributed. The server can be at a client site or at a central site but operated by the application service provider. Application server 1402 is substantially similar to the ASP 102 of FIG. 1.

The application server 1402 includes one or more application(s) 1404 that includes post-processing software for analyzing image data for a specific clinical need. The one or more application(s) 1404 is substantially similar to the one or more healthcare image processing application(s) 104 of FIG. 1 such as the neuro-degenerative disease severity indexing application that references a disease severity knowledgebase which includes a reference database of normal data that is segregated according to application needs, a disease severity knowledgebase—application specific, and processing algorithms. The application server is often referred to as a central site or central server, that being the location of the application service provider.

Apparatus 1400 also includes a customer site 1406, which is a location of a user of the application service. The user is a clinician or medical staff member who uses the application(s) 1404 at a customer site. The customer site 1406 also includes a customer component which is a component at the customer site 1406, such as database (DB) 1408.

The customer site 1406 also includes a communication means 1410 that communicates to and from the application server 1402. The communication means 1410 is performed in a secure environment meeting all HIPAA guidelines for patient privacy. Data communication is preferably through DICOM using internet or intranet. Proprietary communication methods are used for identification of service type, both at the customer end and at the server end. The service type provides appropriate billing (after appropriate discounts). There is a web-based communication that allows for viewing of reports as well as remote access of the application.

Some embodiments of the customer site 1406 also include an administration means which functions as a method that provides account management, access control, security and scheduling. Some embodiments of the customer site 1406 also include web access and a user interface (UI). The web access is provided for remote application instantiation as well as a means to communicate to and from the application server 1402 relating to service procedures.

Apparatus 1400 also includes a domain expert 1412 and a local expert or technician/application specialist 1414.

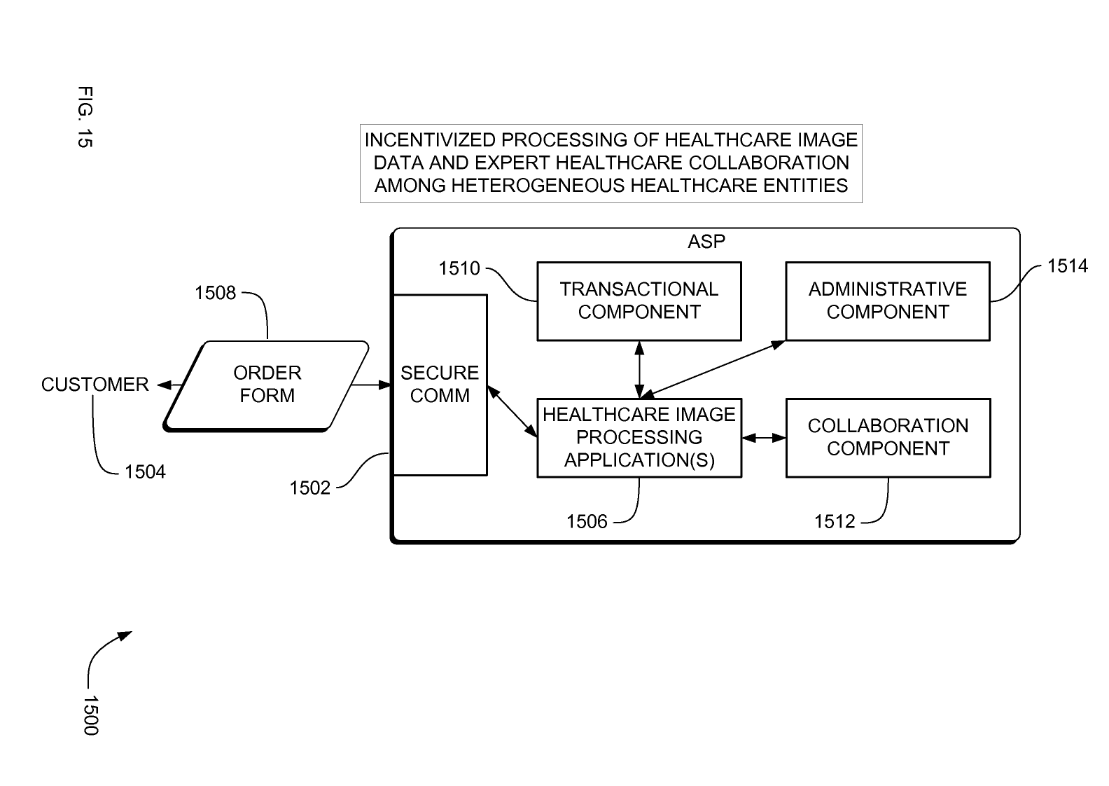

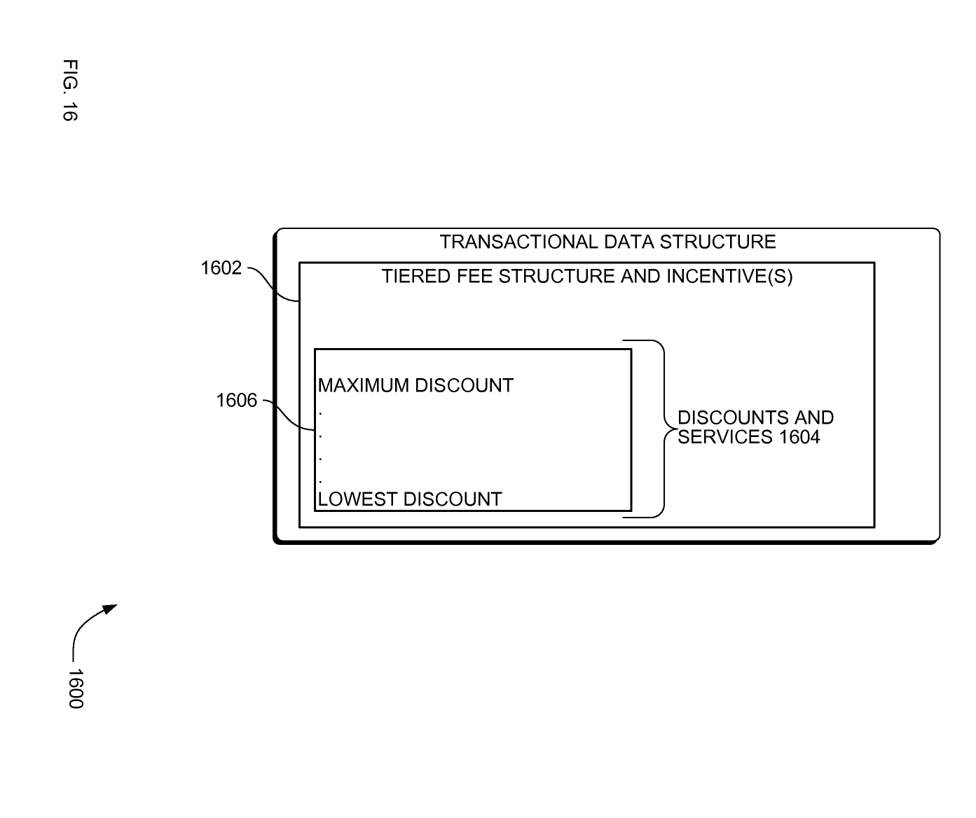

FIGS. 15-16 describe an application service provider system that improves partnership and collaboration of healthcare experts to the larger medical community in the incentivized processing of healthcare image data and expert healthcare collaboration among heterogeneous healthcare entities. FIGS. 15-16 describes efficacious applications processing and distribution of healthcare image data among heterogeneous healthcare entities through an healthcare imaging application that solves the need in the art for less decentralized control, distribution and transmission of data in image processing applications which in turn supports and encourages the widespread adoption and implementation healthcare image processing applications and services.

FIG. 15 is a block diagram of an application service provider system 1500, according to an embodiment. Apparatus 1500 is one embodiment of the ASP 102 in FIG. 1 and the application server 1402 in FIG. 14.

Some embodiments of the application service provider system 1500 include a secure-communication component 1502 that is operable to communicate with a customer 1504. One example of the customer 1504 is healthcare customer 108 in FIG. 1.

Some embodiments of the application service provider system 1500 include an application component 1506 that is operable to receive an order-requisition-form 1508 from the customer 1504 through the secure-communication component 1502. The application component 1506 is operable to perform a healthcare application in reference to the order-requisition-form 1502 to provide results to the customer 1504. In some embodiments of the application service provider system 1500 the healthcare application component 1506 includes an image processing application and/or a medical image processing application and a structured medical processing application.

Some embodiments of the application service provider system 1500 include a transactional component 151 0. The transactional component 1510 is operable to provide a tiered fee structure that includes at least one incentive to the customer 1504.

Some embodiments of the application service provider system 1500 include a collaboration component 1512. The collaboration component 1512 is operable to facilitate collaboration in clarification of results from the application component 1506.

Some embodiments of the application service provider system 1500 include an administrative component 1514. The administrative component 1514 is operable to route the order requisition form 1508. The administrative component 1514 is operable to schedule personnel in reference to tasks of the order requisition form 1508.

FIG. 16 is a diagram of a transactional data structure 1600, according to an embodiment. The transactional data structure 1600 is one embodiment of data structures in the transactional component 1510 in FIG 15 that is operable to provide a tiered fee structure that includes at least one incentive.

The transactional data structure 1600 includes the tiered fee structure and at least one incentive 1602. Some embodiments of the tiered fee structure and incentive(s) 1602 includes a plurality of billing discounts 1604 associated with one of a plurality of customer services.

In some embodiments of the plurality of billing discounts and the plurality of customer services 1604 includes a maximum discount if a customer provides consultancy with gradually decreasing discounts if the customer provides clinical outcome with data and a lowest discount if the customer provides data alone 1606.

In some embodiments of the plurality of billing discounts and the plurality of customer services 1604 includes a first billing discount associated with a customer service of providing image data, a second billing discount associated with a customer service of providing image data and a clinical outcome, and a third billing discount associated with a customer service of providing consultancy on clinical image analysis.

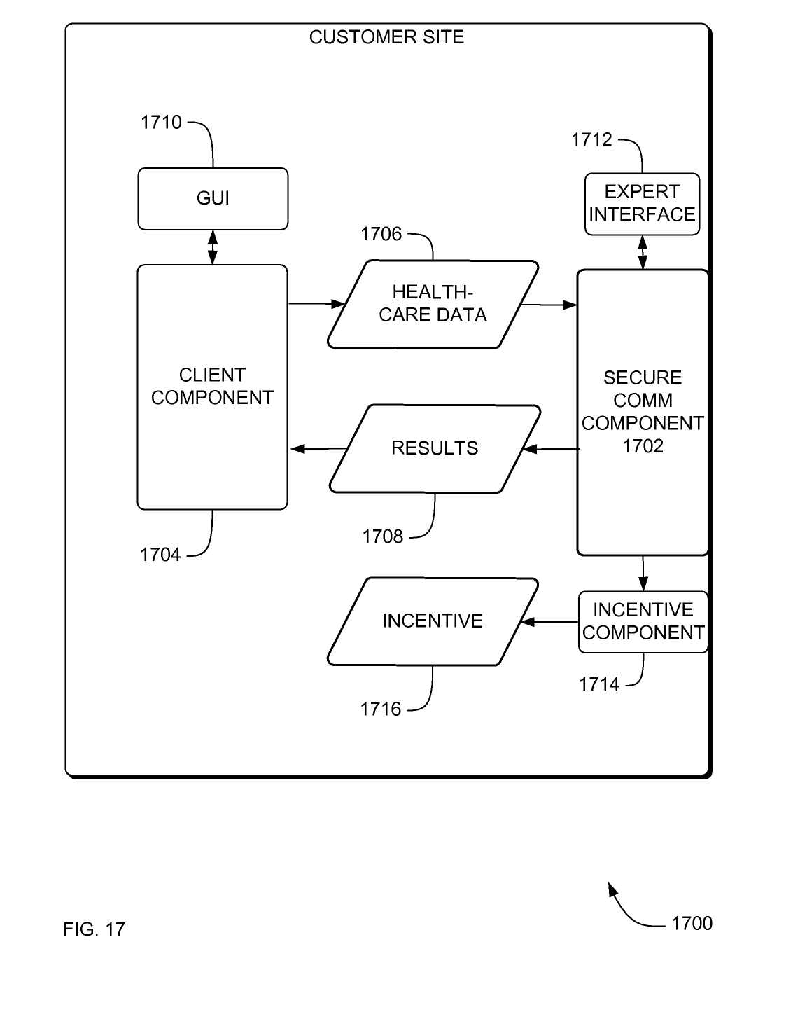

FIGS. 17-28 describe centralized applications processing of healthcare image data from heterogeneous healthcare entities that provides for more efficacious centralized control, distribution and transmission of data in image processing applications which in turn supports and encourages the clinically effective widespread adoption and implementation healthcare image processing applications and services. FIGS. 17-28 also provide collaboration with leading luminary medical experts to obtain expert advice and provide guidance to healthcare customers.

FIG. 17 is a block diagram of customer site 1700 of a network application framework system, according to an embodiment. Customer site 1700 is one embodiment of the healthcare customer 108 in FIG. 1 and one embodiment of the customer site 1406 in FIG. 14.

Some embodiments of customer site 1700 include a secure-communication component 1702. The secure-communication component 1702 is one embodiment of the communication means 1410 in FIG. 14.

Some embodiments of customer site 1700 include a client component 1704 operable to send healthcare data 1706 to a server (not shown; e.g. ASP 102 in FIG. 1 or application server 1402 in FIG. 14) through the secure-communication component 1702. The client component 1704 further operable to receive processing application results 1708 from the server through the secure-communication component 1702.

Some embodiments of customer site 1700 include a graphical user-interface component 1710 that is operable to present the results 1708 that are received from the server. Some embodiments of customer site 1700 include an expert interface component 1712 that is operable to receive healthcare recommendations. Some embodiments of customer site 1700 include an incentive component 1714 operable to receive at least one incentive 1716 through the secure-communication component 1702.

In some embodiments the incentive 1716 includes a maximum discount if the customer provides consultancy with gradually decreasing discounts if the customer provides clinical outcome with data and a lowest discount if the customer provides data alone.

In some embodiments of the customer site 1700, the incentive 1716 includes a first billing discount associated with a customer service of providing image data, a second billing discount associated with a customer service of providing image data and a clinical outcome, and a third billing discount associated with a customer service of providing consultancy on clinical image analysis.

Some embodiments of the customer site 1700 include an image processing application and/or a medical image processing application and a structured medical processing application, such as the healthcare image processing application 104 in FIG. 1 that can include the neuro-degenerative disease severity indexing application that references a disease severity knowledgebase and/or the application(s) 1404 in FIG. 14.

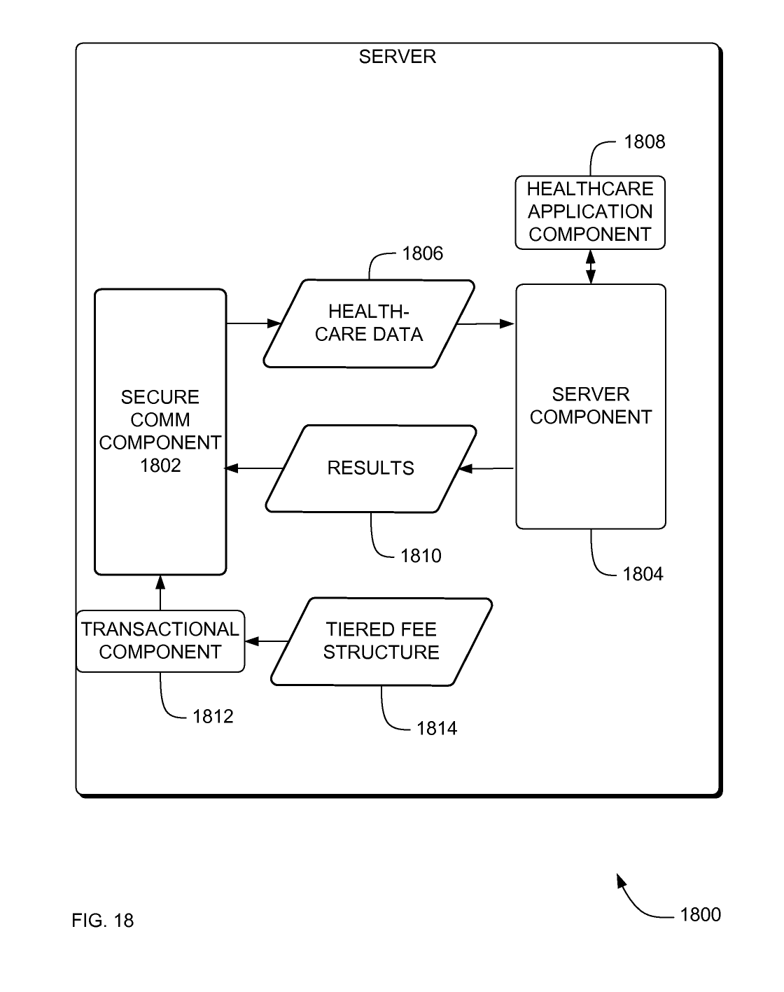

FIG. 18 is a block diagram of a server 1800 of a network application framework system, according to an embodiment. Server 1800 is one embodiment of the ASP 102 in FIG. 1, the application server 1402 in FIG. 14 and/or the ASP 1500 in FIG. 15.

Some embodiments of the server 1800 include a secure-communication component 1802, which can be substantially similar to the secure-communication component 1502 of FIG. 15 and/or the secure-communication component 1702 in FIG. 17.

Some embodiments of the server 1800 include a server component 1804 that is operable to receive data 1806 from a client (not shown) through the secure-communication component. Examples of the client include the healthcare customer 108 in FIG. 1, customer site 1406 in FIG. 14 customer 1504 in FIG. 15 and customer site 1700 in FIG. 17. The data 1806 can include image data and medical image data.

Some embodiments of the server 1800 include a healthcare application component 1808 that is operable to process the data 1806 and operable to generate results 1810. The server component 1804 is operable to send the results 1810 to the client through the secure-communication component 1802. In some embodiments, the healthcare application component 1808 includes post-processing software operable to analyze image data for a specific clinical need.

Some embodiments of the server 1800 include a transactional component 1812 that is operable to provide a tiered fee structure 1814 that includes at least one incentive.

In some embodiments, the tiered fee structure that includes at least one incentive is implemented as the tiered fee structure and incentives 1602 in FIG. 16 that can include a plurality of billing discounts and a maximum discount and a lowest discount, that can include a first billing discount, a second billing discount and a third billing discount.

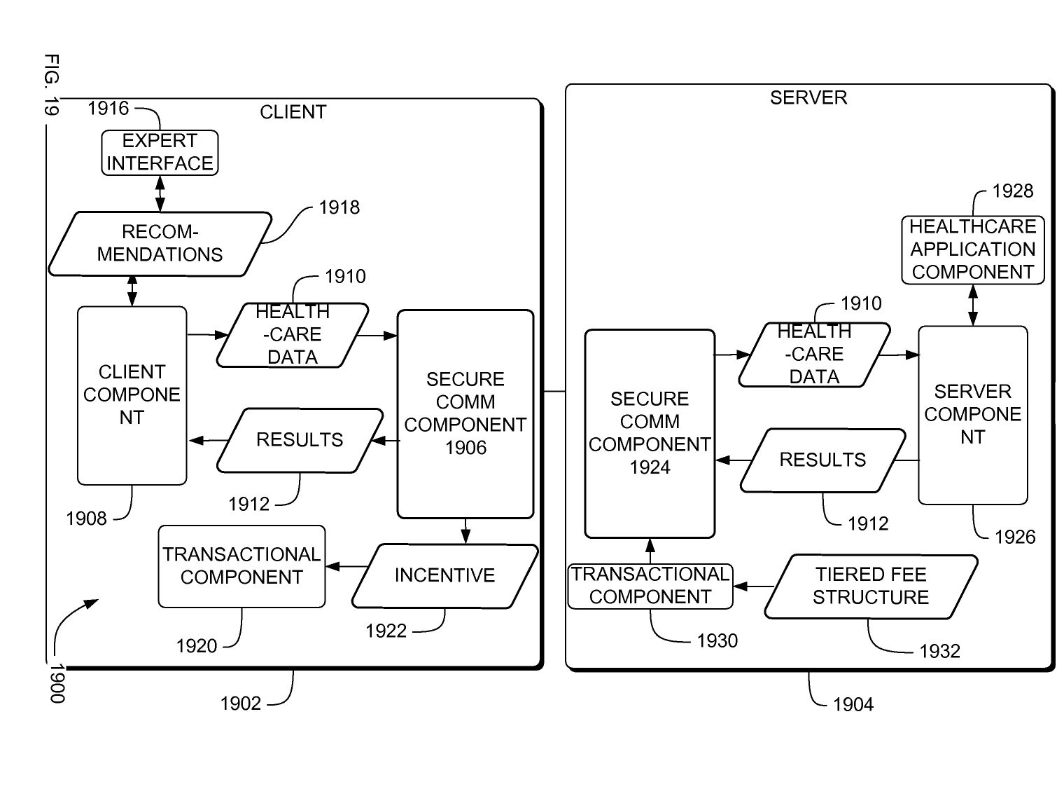

FIG. 19 is a block diagram of a client and server of a network application framework system 1900, according to an embodiment.

The network application framework system 1900 includes a client 1902 and a server 1904.

The client 1902 includes a secure-communication component 1906. The client 1902 includes a client component 1908 that is operable to send data 1910 to the server 1904 through the secure-communication component 1906 and the client component 1908 is also operable to receive results 1912 from the server 1904 through the secure-communication component 1906.

The client 1902 also includes an expert interface component 1916 that is operable to present the results 1912 that are received from the server 1904. The expert interface component 1916 is also operable to receive recommendations 1918.

The client 1902 also includes a client transactional component 1920 that is operable to receive at least one incentive 1922 to an entity that operates the client 1902.

Examples of the client 1902 include the healthcare customer 108 in FIG. 1, customer site 1406 in FIG. 14 customer 1504 in FIG. 15 and customer site 1700 in FIG. The data 1910 can include image data and medical image data.

The server 1904 includes a secure-communication component 1924. The server 1904 includes a server component 1926 that is operable to receive the data 1910 from the client 1902 through the secure-communication component 1924. The server 1904 includes a healthcare application component 1928 that is operable to process the data 1910 and that is operable to generate the results 1912. The server 1904 is operable to send the results 1912 to the client 1902 through the secure-communication component 1924. The server 1904 includes a transactional component 1930 that is operable to provide a tiered fee structure 1932 that includes at least one incentive. Server 1904 is one embodiment of the ASP 102 in FIG. 1, the application server 1402 in FIG. 14 and/or the ASP 1500 in FIG. 15.

In some embodiments, the tiered fee structure 1932 and the at least one incentive is implemented as the tiered fee structure and incentives 1602 in FIG. 16 that can include a plurality of billing discounts and a maximum discount and a lowest discount, that can include a first billing discount, a second billing discount and a third billing discount.

Some embodiments of the healthcare application component 1928 include an image processing application and/or a medical image processing application and a structured medical processing application, such as the healthcare image processing application 104 in FIG. 1 that can include the neuro-degenerative disease severity indexing application that references a disease severity knowledgebase and/or the application(s) 1404 in FIG. 14.

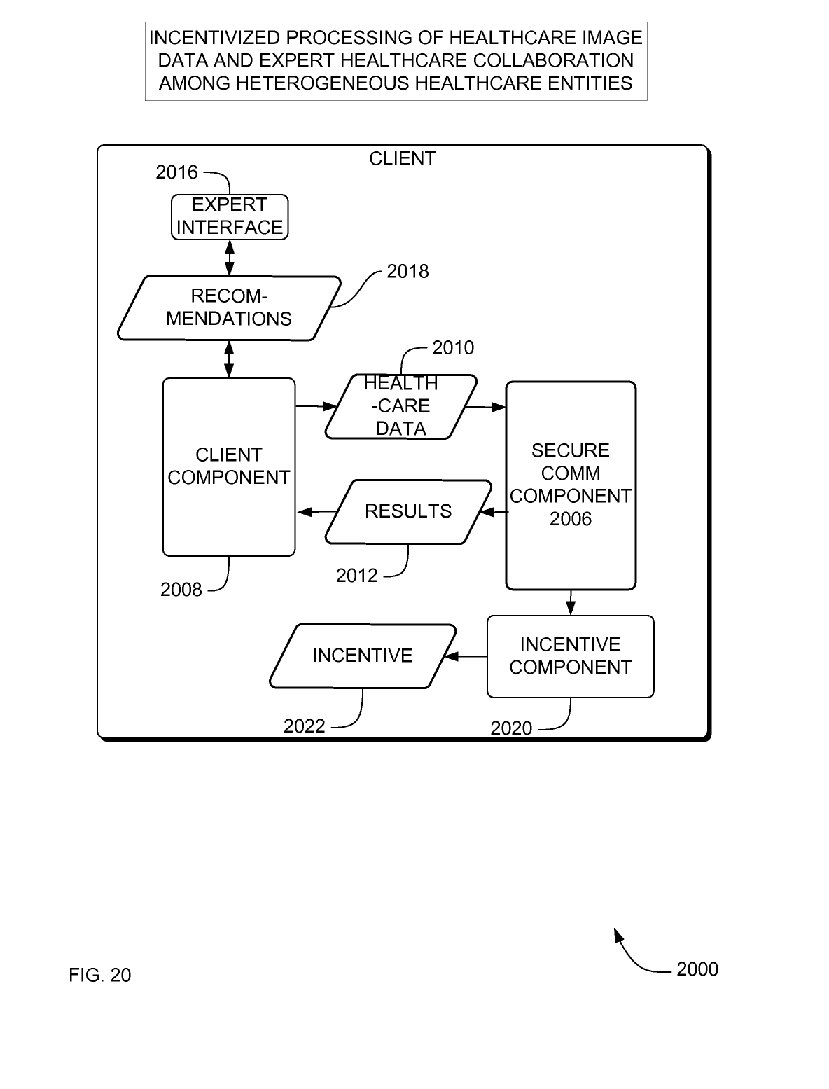

FIG. 20 is a block diagram of a client 2000 in a network application framework system, according to an embodiment.

The client 2000 includes a secure-communication component 2006. The client 2000 includes a client component 2008 that is operable to send data 2010 to a server through the secure-communication component 2006 and the client component 2008 is also operable to receive results 2012 from the server through the secure-communication component 2006. In some embodiments, the data 2010 is one of healthcare image data and healthcare image data and structured healthcare data and structured healthcare image data.

The client 2000 also includes an expert interface component 2016 that is operable to present the results 2012 that are received from the server. The expert interface component 2016 is also operable to receive recommendations 2018.

The client 2000 also includes an incentive component 2020 that is operable to receive a plurality of incentives 2022 for expert advice to an entity that operates the client 2000.

Examples of the client 2000 include the healthcare customer 108 in FIG. 1, customer site 1406 in FIG. 14 customer 1504 in FIG. 15 and customer site 1700 in FIG. 17. The data 2010 can include image data and medical image data.

In some embodiments, the plurality of incentives 2022 is implemented as the tiered fee structure and incentives 1602 in FIG. 16 that can include a plurality of billing discounts and a maximum discount and a lowest discount, that can include a first billing discount, a second billing discount and a third billing discount.

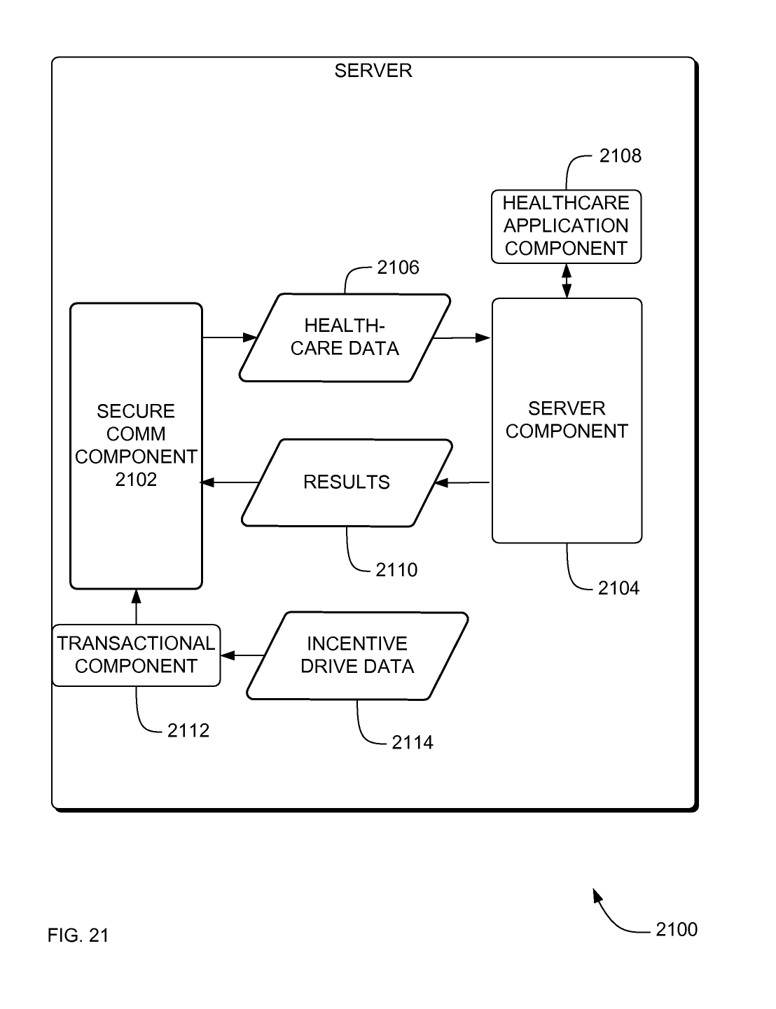

FIG. 21 is a block diagram of a server 2100 of a network application framework system, according to an embodiment. Server 2100 is one embodiment of the ASP 102 in FIG. 1, the application server 1402 in FIG. 14 and/or the ASP 1500 in FIG. 15.

Some embodiments of the server 2100 include a secure-communication component 2103, which can be substantially similar to the secure-communication component 1502 of FIG. 15 and/or the secure-communication component 1702 in FIG. 17.

Some embodiments of the server 2100 include a server component 2104 that is operable to receive data 2106 from a client (not shown) through the secure-communication component. Examples of the client include the healthcare customer 108 in FIG. 1, customer site 1406 in FIG. 14 customer 1504 in FIG. 15 and customer site 1700 in FIG. 17. The data 2106 can include image data and medical image data.

Some embodiments of the server 2100 include a healthcare application component 2108 that is operable to process the data 2106 and operable to generate results 2110. The server component 2104 is operable to send the results 2110 to the client through the secure-communication component 2102. In some embodiments, the healthcare application component 2108 includes post-processing software operable to analyze image data for a specific clinical need.

Some embodiments of the server 2100 include a transactional component 2112 that is operable to provide a plurality of incentive driven data 2114. In some embodiments, the incentive driven data is one of data, data plus outcome and data plus outcome plus consultancy. In some further embodiments, the incentive driven data is implemented as the tiered fee structure and incentives 1602 in FIG. 16 that can include a plurality of billing discounts and a maximum discount and a lowest discount, that can include a first billing discount, a second billing discount and a third billing discount.

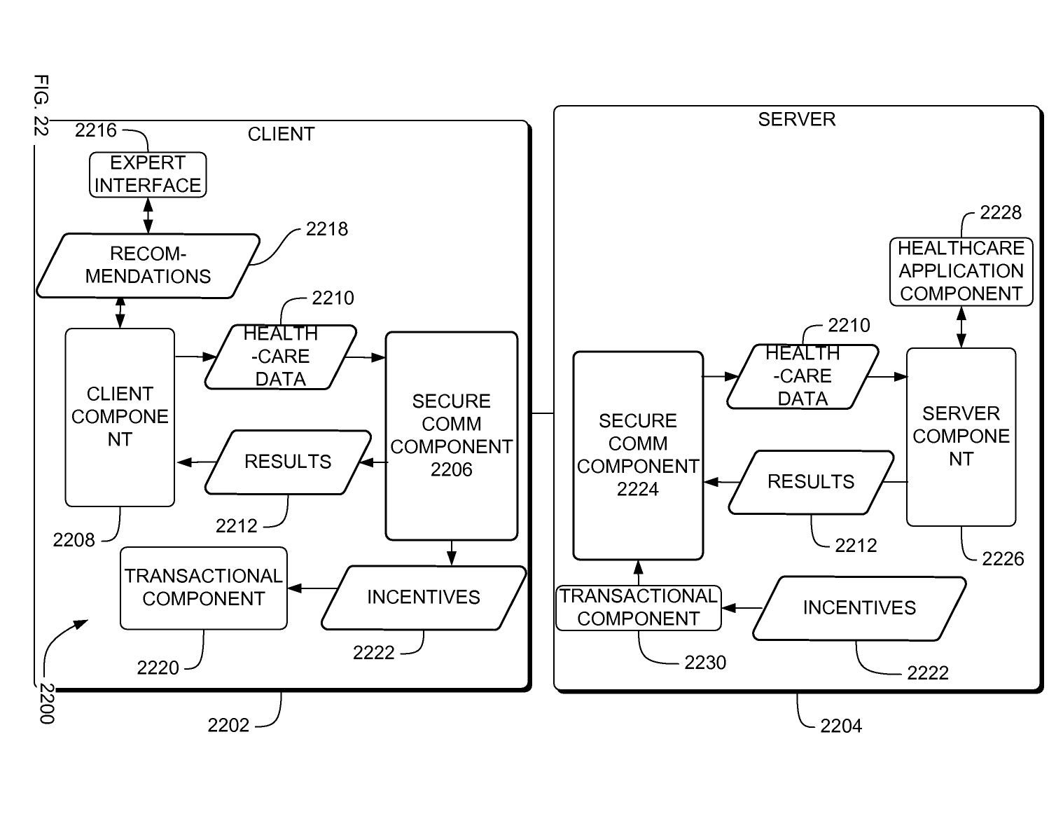

FIG. 22 is a block diagram of a client and server of a network application framework system 2200, according to an embodiment.

The network application framework system 2200 includes a client 2202 and a server 2204.

The client 2202 includes a secure-communication component 2206. The client 2202 includes a client component 2208 that is operable to send data 2210 to the server 2204 through the secure-communication component 2206 and the client component 2208 is also operable to receive results 2212 from the server 2204 through the secure-communication component 2206.

The client 2202 also includes an expert interface component 2216 that is operable to present the results 2212 that are received from the server 2204. The expert interface component 2216 is also operable to receive recommendations 2218.

The client 2202 also includes a client transactional component 2220 that is operable to receive at plurality of incentives 2222 for expert advice to an entity that operates the server 2204.

Examples of the client 2202 include the healthcare customer 108 in FIG. 1, customer site 1406 in FIG. 14 customer 1504 in FIG. 15 and customer site 1700 in FIG. 17. The data 2210 can include image data and medical image data.

The server 2204 includes a secure-communication component 2224. The server 2204 includes a server component 2226 that is operable to receive the data 2210 from the client 2202 through the secure-communication component 2224. The server 2204 includes a healthcare application component 2228 that is operable to process the data 2210 and that is operable to generate the results 2212. The server 2204 is operable to send the results 2212 to the client 2202 through the secure-communication component 2224. The server 2204 includes a transactional component 2230 that is operable to provide the plurality of incentives 2222. Server 2204 is one embodiment of the ASP 102 in FIG. 1, the application server 1402 in FIG. 14 and/or the ASP 1500 in FIG. 15.

In some embodiments, the incentives 2222 are implemented as the tiered fee structure and incentives 1602 in FIG. 16 that can include a plurality of billing discounts and a maximum discount and a lowest discount, that can include a first billing discount, a second billing discount and a third billing discount.

Some embodiments of the healthcare application component 2228 include an image processing application and/or a medical image processing application and a structured medical processing application, such as the healthcare image processing application 104 in FIG. 1 that can include the neuro-degenerative disease severity indexing application that references a disease severity knowledgebase and/or the application(s) 1404 in FIG. 14.

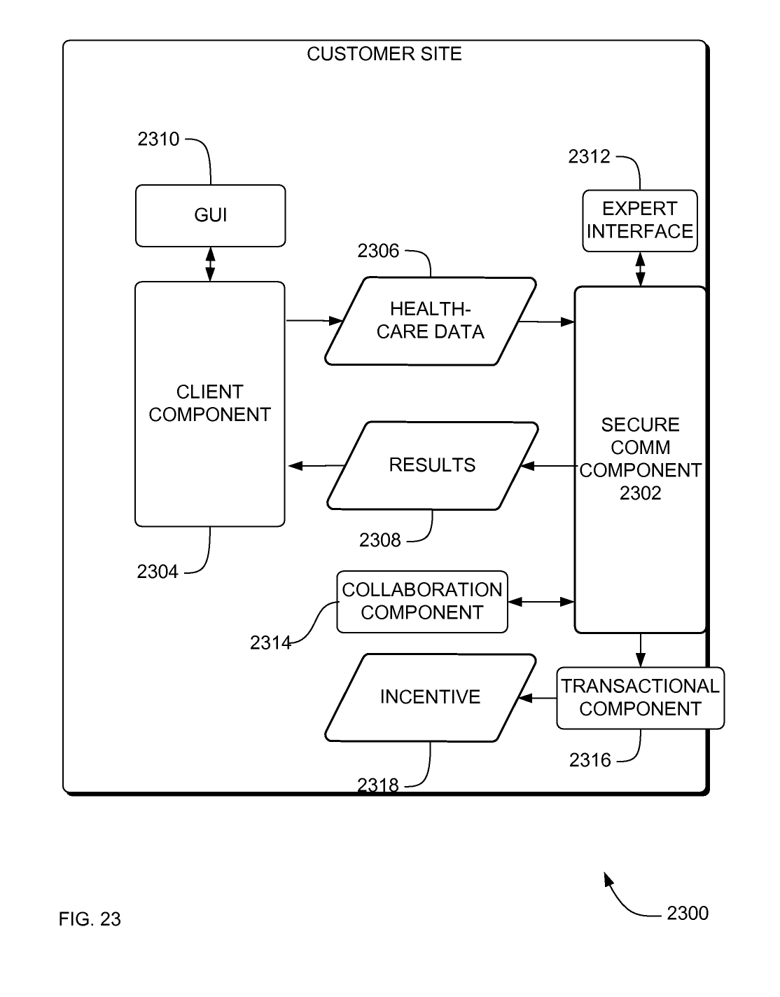

FIG. 23 is a block diagram of customer site 2300 of a network application framework system, according to an embodiment. Customer site 2300 is one embodiment of the healthcare customer 108 in FIG. 1 and one embodiment of the customer site 1406 in FIG. 14.

Some embodiments of customer site 2300 include a secure-communication component 2302. The secure-communication component 2302 is one embodiment of the communication means 1410 in FIG. 14.

Some embodiments of customer site 2300 include a client component 2304 operable to send healthcare data 2306 to a server (not shown; e.g. ASP 102 in FIG. 1 or application server 1402 in FIG. 14) through the secure-communication component 2302. The client component 2304 is further operable to receive processing application results 2308 from the server through the secure-communication component 2302.

Some embodiments of customer site 2300 include a graphical user-interface component 2310 that is operable to present the results 2308 that are received from the server. Some embodiments of customer site 2300 include an expert interface component 2312 that is operable to receive healthcare recommendations.

Some embodiments of customer site 2300 include a collaboration component 2314 that is operable to facilitate collaboration in clarification of the results 2308 through the secure-communication component 2302.

Some embodiments of customer site 2300 include a transactional component 2316 that is operable to receive a plurality of incentives 2318.

In some embodiments, the incentives 2318 are implemented as the tiered fee structure and incentives 1602 in FIG. 16 that can include a plurality of billing discounts and a maximum discount and a lowest discount, that can include a first billing discount, a second billing discount and a third billing discount.

In some embodiments the incentives 2318 include a maximum discount if the customer provides consultancy with gradually decreasing discounts if the customer provides clinical outcome with data and a lowest discount if the customer provides data alone.

In some embodiments of the customer site 2300, the incentive 2318 includes a first billing discount associated with a customer service of providing image data, a second billing discount associated with a customer service of providing image data and a clinical outcome, and a third billing discount associated with a customer service of providing consultancy on clinical image analysis.

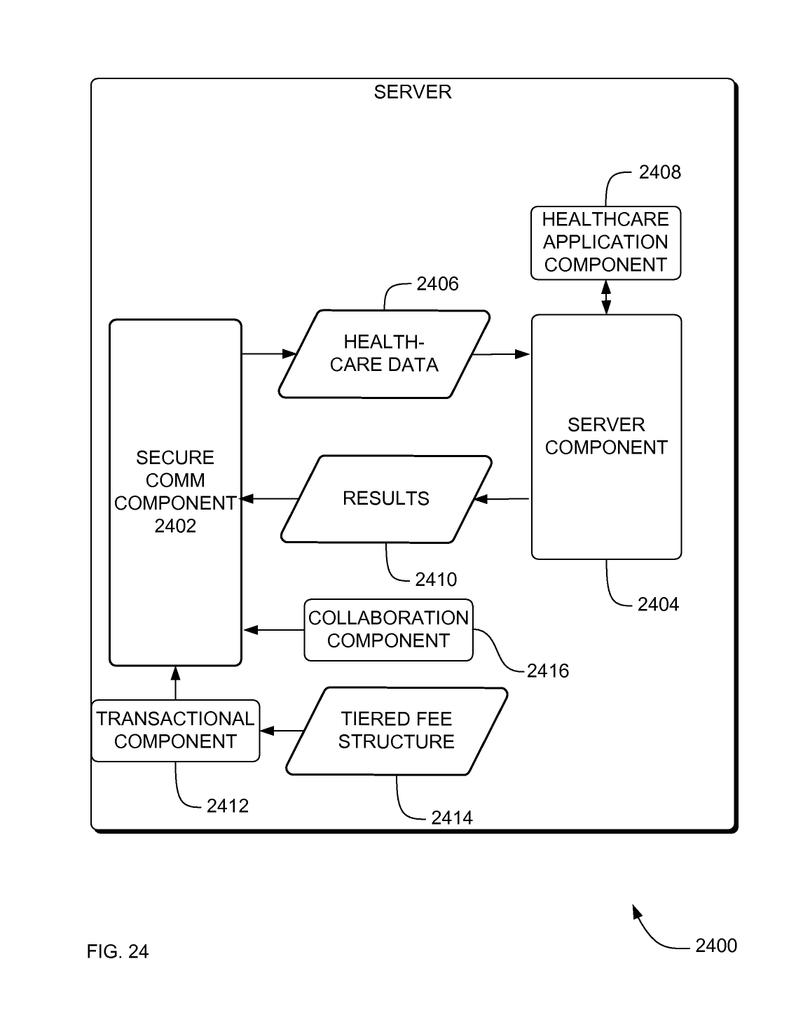

FIG. 24 is a block diagram of a server 2400 of a network application framework system, according to an embodiment. Server 2400 is one embodiment of the ASP 102 in FIG. 1, the application server 1402 in FIG. 14 and/or the ASP 1500 in FIG. 15.

Some embodiments of the server 2400 include a secure-communication component 2402, which can be substantially similar to the secure-communication component 1502 of FIG. 15 and/or the secure-communication component 1702 in FIG. 17.

Some embodiments of the server 2400 include a server component 2404 that is operable to receive data 2406 from a client (not shown) through the secure-communication component. Examples of the client include the healthcare customer 108 in FIG. 1, customer site 1406 in FIG. 14 customer 1504 in FIG. 15 and customer site 1700 in FIG. 17. The data 2406 can include image data and medical image data.

Some embodiments of the server 2400 include a healthcare application component 2408 that is operable to process the data 2406 and operable to generate results 2410. The server component 2404 is operable to send the results 2410 to the client through the secure-communication component 2402. In some embodiments, the healthcare application component 2408 includes post-processing software operable to analyze image data for a specific clinical need.

Some embodiments of the server 2400 include a transactional component 2412 that is operable to provide a tiered fee structure 2414 that includes at least one incentive.

In some embodiments, the tiered fee structure that includes at least one incentive is implemented as the tiered fee structure and incentives 1602 in FIG. 16 that can include a plurality of billing discounts and a maximum discount and a lowest discount, that can include a first billing discount, a second billing discount and a third billing discount.

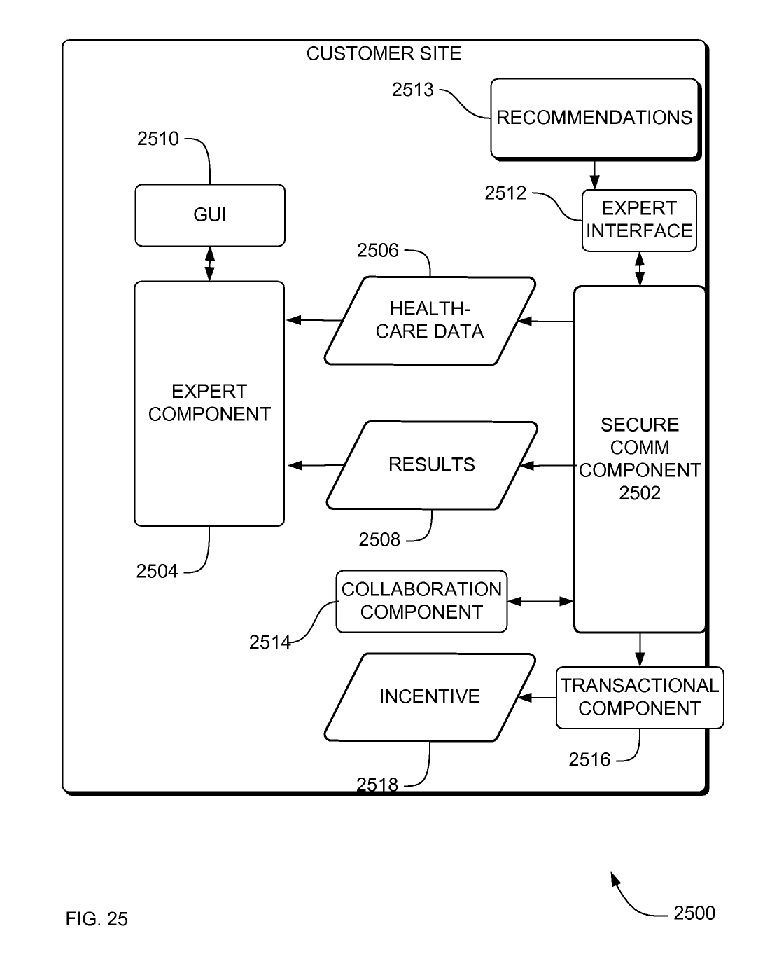

Some embodiments of the server 2400 include a collaboration component 2416 that is operable to facilitate collaboration in clarification of the results 2410. FIG. 25 is a block diagram of expert site 2500 of a network application framework system, according to an embodiment. Expert site 2500 is one embodiment of the healthcare expert 106 in FIG. 1 and one embodiment of the domain expert 1412 and the local expert 1414 in FIG. 14.

Some embodiments of expert site 2500 include a secure-communication component 2502.

Some embodiments of expert site 2500 include an expert component 2504 operable to receive healthcare data 2506 from a server (not shown; e.g. ASP 102 in FIG. 1 or application server 1402 in FIG. 14) through the secure-communication component 2502. The expert component 2504 is further operable to receive processing application results 2508 from the server through the secure-communication component 2502.

Some embodiments of expert site 2500 include a graphical user-interface component 2510 that is operable to present the results 2508 that are received from the server. Some embodiments of expert site 2500 include an expert interface component 2512 that is operable to receive healthcare recommendations 2513 from an operator of the expert site 2500.

Some embodiments of expert site 2500 include a collaboration component 2514 that is operable to facilitate collaboration in clarification of the results 2508 through the secure-communication component 2502.

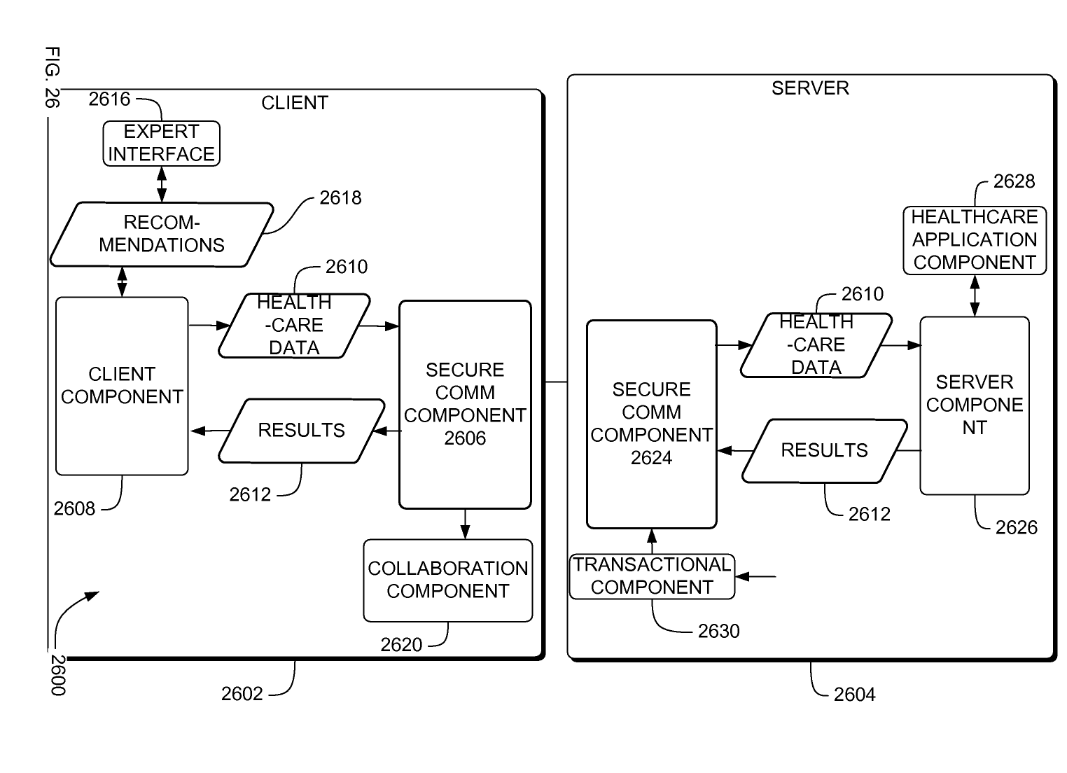

FIG. 26 is a block diagram of a client and server of a network application framework system 2600, according to an embodiment.

The network application framework system 2600 includes a client 2602 and a server 2604.

The client 2602 includes a secure-communication component 2606. The client 2602 includes a client component 2608 that is operable to send data 2610 to the server 2604 through the secure-communication component 2606 and the client component 2608 is also operable to receive results 2612 from the server 2604 through the secure-communication component 2606.

The client 2602 also includes an expert interface component 2616 that is operable to present the results 2612 that are received from the server 2604. The expert interface component 2616 is also operable to receive recommendations 2618.

The client 2602 also includes a client collaboration component 2620 that is operable to facilitate collaboration in clarification of the results 2612 and the recommendations 2618.

Examples of the client 2602 include the healthcare customer 108 in FIG. 1, customer site 1406 in FIG. 14 customer 1504 in FIG. 15 and customer site 1700 in FIG. 17. The data 2610 can include image data and medical image data.

The server 2604 includes a secure-communication component 2624. The server 2604 includes a server component 2626 that is operable to receive the data 2610 from the client 2602 through the secure-communication component 2624. The server 2604 includes a healthcare application component 2628 that is operable to process the data 2610 and that is operable to generate the results 2612. The server 2604 is operable to send the results 2612 to the client 2602 through the secure-communication component 2624. The server 2604 includes a collaboration component 2630 that is operable to to facilitate collaboration in clarification of the results and the recommendations. Server 2604 is one embodiment of the ASP 102 in FIG. 1, the application server 1402 in FIG. 14 and/or the ASP 1500 in FIG. 15.

Some embodiments of the healthcare application component 2628 include an image processing application and/or a medical image processing application and a structured medical processing application, such as the healthcare image processing application 104 in FIG. 1 that can include the neuro-degenerative disease severity indexing application that references a disease severity knowledgebase and/or the application(s) 1404 in FIG. 14.

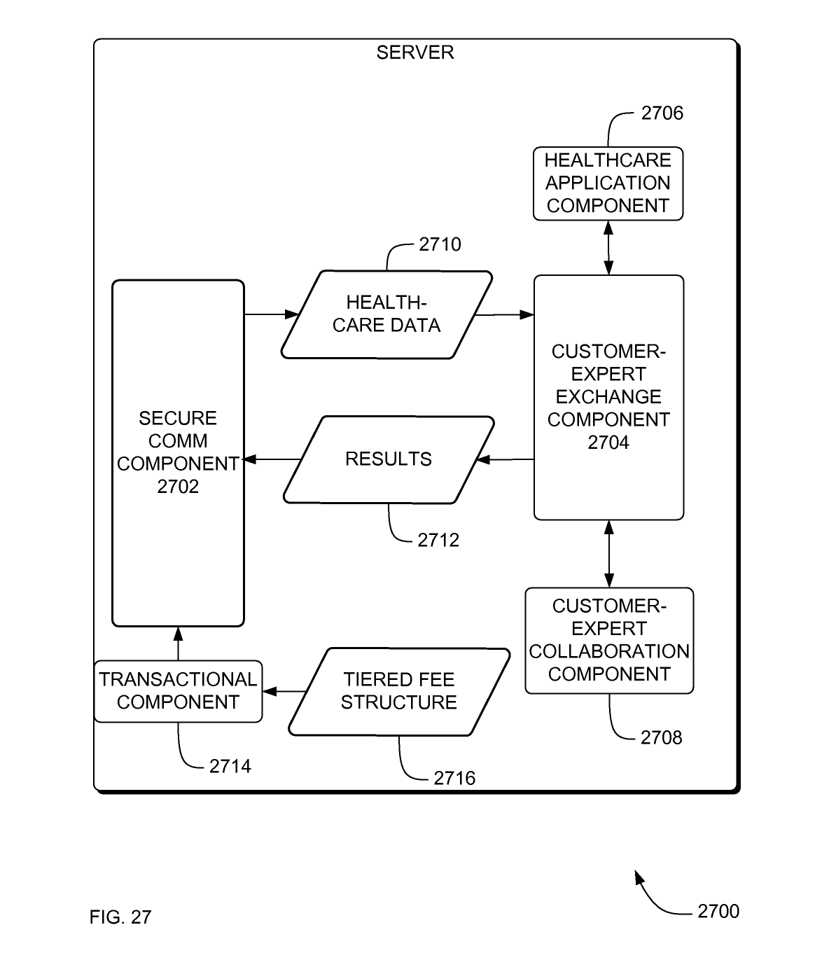

FIG. 27 is a block diagram of a system 2700 that supports collaboration between a customer and a healthcare expert, according to an embodiment. System 2700 is one embodiment of the ASP 102 in FIG. 1, the application server 1402 in FIG. 14 and/or the ASP 1500 in FIG. 15.

Some embodiments of the system 2700 include a secure-communication component 2702 that is operable to communicate with the customer and the healthcare expert moderate the exchange between the customer and the healthcare expert. In some embodiments, the secure-communication component 2702 is substantially similar to the secure-communication component 1502 of FIG. 15 and/or the secure-communication component 1702 in FIG. 17.

Some embodiments of the system 2700 include a secure customer-expert exchange component 2704 that is operable to moderate the exchange between the customer and the healthcare expert using a structured healthcare processing application component 2706. In some embodiments, the exchange consists essentially of between the customer and the healthcare expert.

Some embodiments of the system 2700 include a collaboration component 2708 that is operable to exchange data between the customer and the healthcare expert through the customer-expert exchange component 2704 and the secure-communication component 2702. In some embodiments, the data includes healthcare image data 2710 received from the customer and/or results of neuro-degenerative disease severity index processing of the healthcare image data 2712.

Some embodiments of the healthcare processing application component 2706 is operable to process the data and operable to generate results 2712. The customer-expert exchange component 2704 is operable to send the results 2712 to the client through the secure-communication component 2702. In some embodiments, the healthcare application component 2708 includes post-processing software operable to analyze image data for a specific clinical need.

Some embodiments of the system 2700 include a transactional component 2714 that is operable to provide a tiered fee structure 2716 that includes at least one incentive. In some embodiments, the tiered fee structure that includes at least one incentive is implemented as the tiered fee structure and incentives 1602 in FIG. 16 that can include a plurality of billing discounts and a maximum discount and a lowest discount, that can include a first billing discount, a second billing discount and a third billing discount.

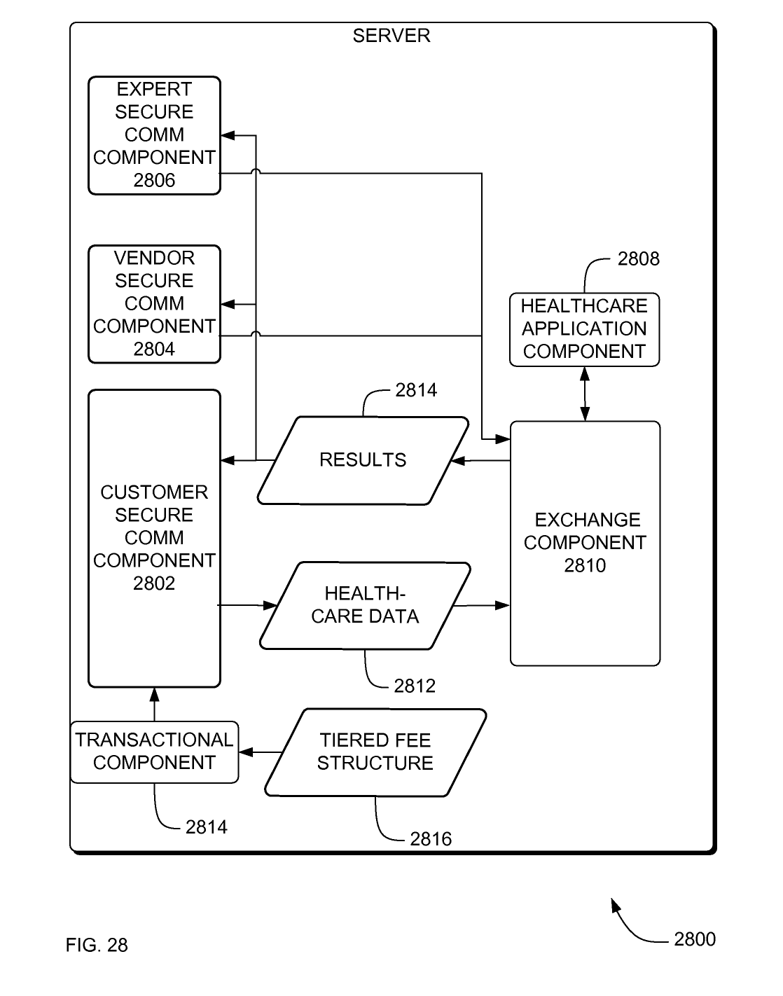

FIG. 28 is a block diagram of a system 2800 that supports collaboration between a customer and a healthcare expert, according to an embodiment. System 2800 is one embodiment of the ASP 102 in FIG. 1, the application server 1402 in FIG. 14 and/or the ASP 1500 in FIG. 15.

Some embodiments of the system 2800 include a customer secure-communication component 2802 that is operable to communicate with the customer. Some embodiments of the system 2800 include a vendor secure-communication component 2804 that is operable to communicate with the vendor.

Some embodiments of the system 2800 include an expert secure-communication component 2806 that is operable to communicate with a healthcare domain expert. The healthcare domain expert is typically a clinical luminary having in-depth knowledge in interpreting results generated by a healthcare application 2808, the healthcare application 2802 including a healthcare image post-processing software operable to analyze image data for a specific clinical healthcare need.

In some embodiments, the data includes healthcare image data 2812 received from the customer and/or results of neuro-degenerative disease severity index processing of the healthcare image data 2814.

In some embodiments, the customer secure-communication component 2802, the vendor secure-communication component 2804 and the expert secure-communication component 2806 is substantially similar to the secure-communication component 1502 of FIG. 15 and/or the secure-communication component 1702 in FIG. 17. In some embodiments, the customer secure-communication component 2802, the vendor secure-communication component 2804 and the expert secure-communication component 2806 are comprised of a singular secure-communication component.

Some embodiments of the system 2800 include an exchange component 2810 that is operable to moderate an exchange between the customer, the vendor and the healthcare expert.

Some embodiments of the healthcare processing application component 2806 is operable to process the data and operable to generate results 2812. The customer-expert exchange component 2804 is operable to send the results 2812 to the client through the secure-communication component 2802. In some embodiments, the healthcare application component 2808 includes post-processing software operable to analyze image data for a specific clinical need.

Some embodiments of the system 2800 include a transactional component 2814 that is operable to provide a tiered fee structure 2816 that includes at least one incentive. In some embodiments, the tiered fee structure that includes at least one incentive is implemented as the tiered fee structure and incentives 1602 in FIG. 16 that can include a plurality of billing discounts and a maximum discount and a lowest discount, that can include a first billing discount, a second billing discount and a third billing discount.

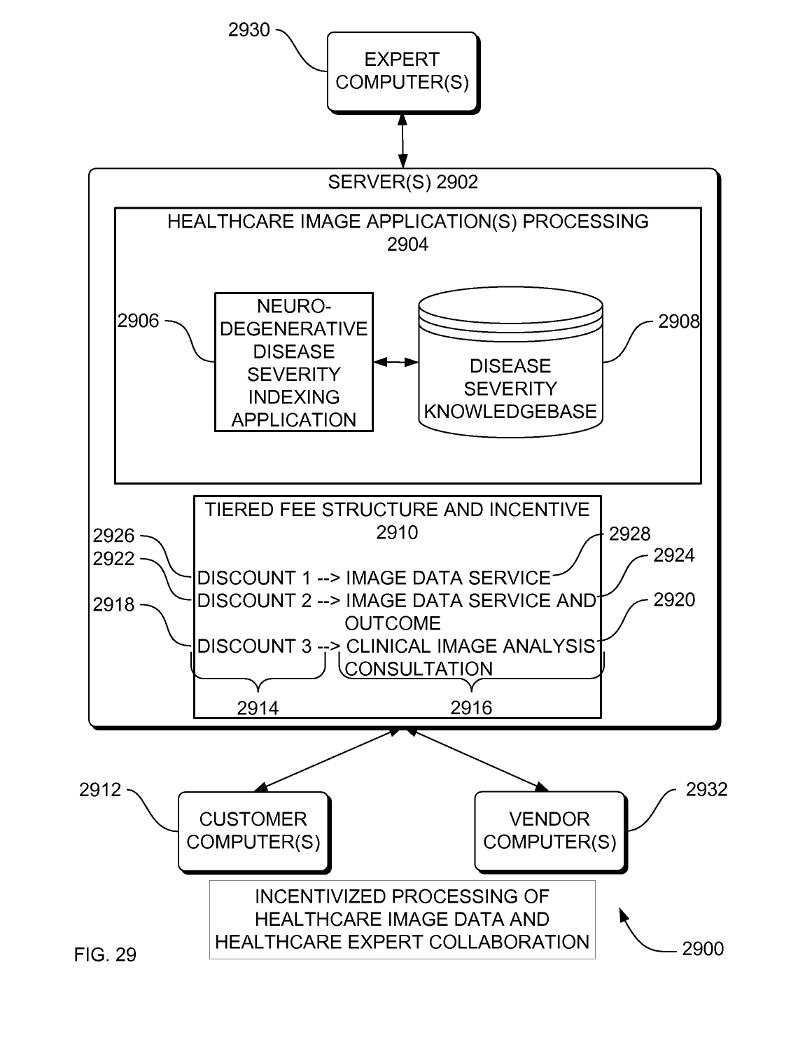

FIGS. 29-31 describe systems in which a central server accesses and aggregates healthcare clinical data from data generating sites, thus reducing logistical and transactional complexities and improving access of clinical databases from the data generating sites.

FIG. 29 is a block diagram of a web-based plurality of operably coupled computers 2900 to provide centralized communication and healthcare image processing applications between a client and server.

The web-based plurality of operably coupled computers 2900 includes one or more server(s) 2902, having healthcare image processing applications 2904. Server 2902 is substantially similar to the ASP 102 of FIG. 1.

The healthcare image processing applications 2904 includes post-processing software for analyzing image data for a specific clinical need. In some embodiments, the healthcare image processing applications 2904 is substantially similar to the one or more healthcare image processing application(s) 104 of FIG. 1, such as the neuro-degenerative disease severity indexing application 2906 that references a disease severity knowledgebase 2908 which includes a reference database of normal's that are segregated according to application needs, a disease severity knowledgebase being application specific and including processing algorithms. The server(s) 2902 are often referred to as a central site or central server.

The web-based plurality of operably coupled computers 2900 includes a data structure 2910 identifying a tiered fee structure and at least one incentive. Data structure 2910 is included in one or more of the server(s) 2902, at least one client 2912, or one or more server(s) 2902 and client(s) 2912.

In some embodiments, the data structure 2910 includes a plurality of billing discounts 2914, each of the billing discounts 2914 associated with one of a plurality of customer services 2916. In some embodiments, the plurality of billing discounts 2914 and the plurality of customer services 2916 includes a maximum discount 2918 if a customer provides consultancy 2920 with gradually decreasing discounts 2922 if the customer provides clinical outcome with data 2924 and a lowest discount 2926 if the customer provides data alone 2928. In some embodiments, the plurality of billing discounts 2914 and the plurality of customer services 2916 include a first billing discount 2916 associated with a customer service of providing image data 2928; a second billing discount 2922 associated with a customer service of providing image data and a clinical outcome 2924; and a third billing discount 2918 associated with a customer service of providing consultancy on clinical image analysis 2920.

In some embodiments, the web-based plurality of operably coupled computers 2900 includes at least one computer 2930 that is operated by an expert of medical services and that is operably coupled to the server(s) 2902. Furthermore, the data structure 2910 is transmitted through the server(s) 2902 from the expert computer(s) 2930 to the customer computer(s) 2912.

In some embodiments, the web-based plurality of operably coupled computers 2900 includes at least one computer 2932 that is operated by a vendor of medical services and that is operably coupled to the server(s) 2902.

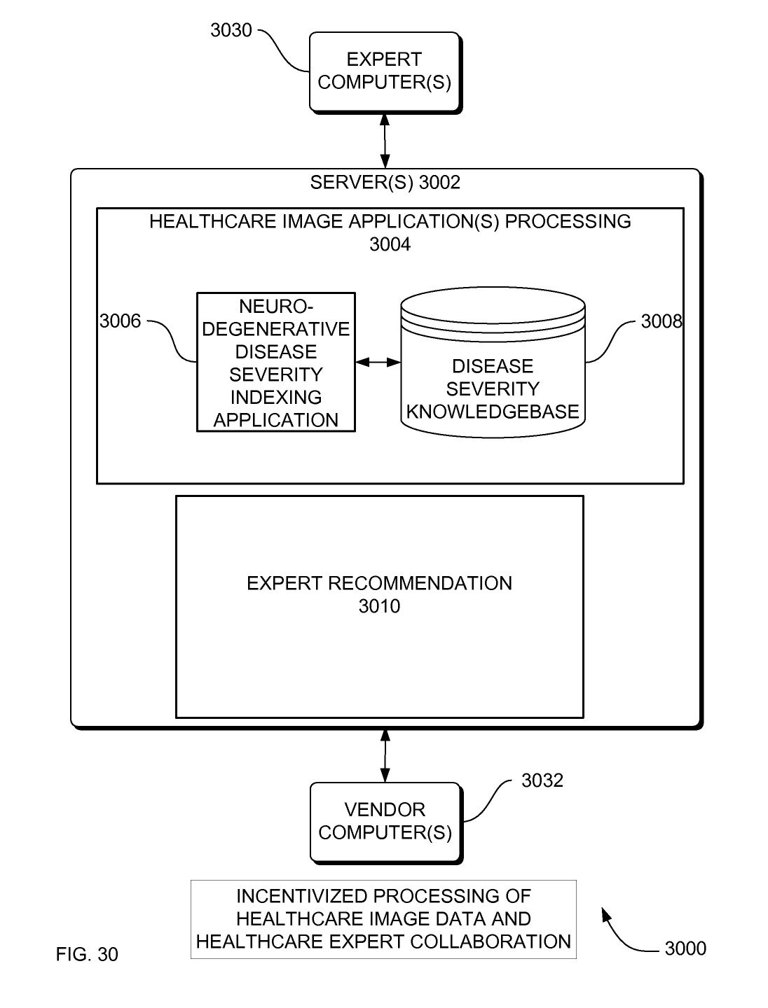

FIG. 30 is a block diagram of a web-based plurality of operably coupled computers 3000 to provide centralized communication and healthcare image processing applications between a client and server.

The web-based plurality of operably coupled computers 3000 includes one or more server(s) 3002, having healthcare image processing applications 3004. Server 3002 is substantially similar to the ASP 102 of FIG. 1.

The healthcare image processing applications 3004 includes post-processing software for analyzing image data for a specific clinical need. In some embodiments, the healthcare image processing applications 3004 is substantially similar to the one or more healthcare image processing application(s) 104 of FIG. 1, such as the neuro-degenerative disease severity indexing application 3006 that references a disease severity knowledgebase 3008 which includes a reference database of normal's that are segregated according to application needs, a disease severity knowledgebase being application specific and including processing algorithms. The server(s) 3002 are often referred to as a central site or central server.

The web-based plurality of operably coupled computers 3000 includes a data structure 3010 that identifies at least one expert recommendation. Data structure 3010 is included in one or more of the server(s) 3002, or one or more server(s) 3002.

In some embodiments, the web-based plurality of operably coupled computers 3000 includes at least one computer 3030 that is operated by an expert of medical services and that is operably coupled to the server(s) 3002. Furthermore, the data structure 3010 is transmitted through the server(s) 3002 from the expert computer(s) 3030 to the vendor computer(s) 3032.

In some embodiments, the web-based plurality of operably coupled computers 3000 includes at least one computer 3032 that is operated by a vendor of medical services and that is operably coupled to the server(s) 3002.

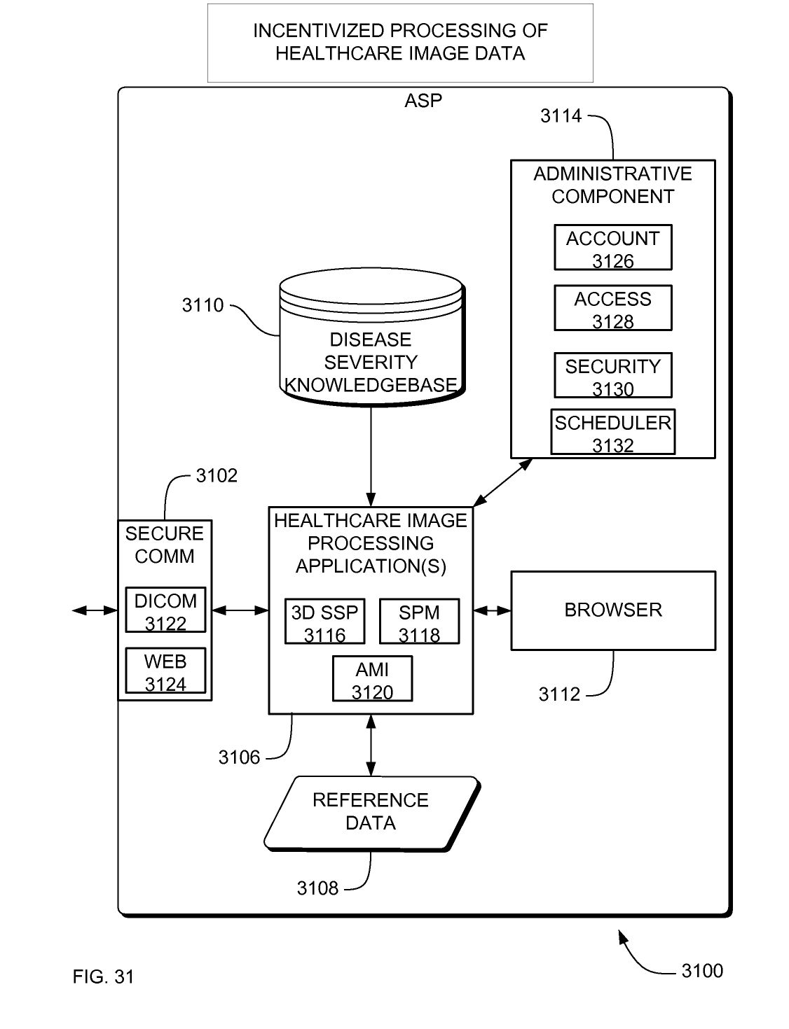

FIG. 31 is a block diagram of an application service provider system 3100, according to an embodiment. Apparatus 3100 is one embodiment of the ASP 102 in FIG. 1 and the application server 1402 in FIG. 14.

Some embodiments of the application service provider system 3100 include a secure-communication component 3102 that is operable to communicate with external electronic device.

Some embodiments of the application service provider system 3100 include an application component 3106 (e.g. a processing algorithm component) that is operable to perform a healthcare application to provide results. In some embodiments of the application service provider system 3100 the healthcare application component 3106 includes an image processing application and/or a medical image processing application and a structured medical processing application.

Some embodiments of the application service provider system 3100 include a reference data 3108 that is accessible to the application component 3106.

Some embodiments of the application service provider system 3100 include a disease severity knowledgebase 3110 that is accessible to the application component 3106.

Some embodiments of the application service provider system 3100 include a browser 3112 or other Internet access component that includes a graphical user interface. The browser 3112 is operably coupled to the application component 3106.

Some embodiments of the application service provider system 3100 include an administrative component 3114. The administrative component 3114 is operable to schedule personnel.

In some embodiments of the application service provider system 3100, the application component 3106 includes a 3D-SSP processing algorithm component 3116; a SPM processing algorithm component 3118 and/or a AMI processing algorithm component 3120.

Some embodiments of the reference data 3108 include at least one of a normalized reference data with reference to at least one tracer, age-segregated reference data and/or reference data segregated with reference to non-age criteria.

Some embodiments of the secure-communication layer include at least one of a DICOM secure-communication layer 3122 and a web-based secure-communication layer 3124.

Some embodiments of the administration component 3114 include at least one of: an account management administration layer 3126, an access control administration layer 3128, a security administration layer 3130, and a scheduling administration layer 3132. Some embodiments of the browser 3112 include at least one of an application Internet access component and an infrastructure Internet access component.

Apparatus components of the FIGS. 14-31 can be embodied as computer hardware circuitry or as a computer-readable program, or a combination of both. More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 1302 in FIG. 13, or on at least as many computers as there are components.

### Conclusion

A network application framework system is described. A technical effect of the network application framework system is to provide a centralized collaboration between a healthcare vendor, a healthcare customer and a healthcare expert. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, database and communication environments and alternate technologies which provide the same functionality as described herein.

We claim:

1. A web-based plurality of operably coupled computers comprising:
at least one server, having healthcare image processing applications; and
at least one client,
wherein a data structure identifying a tiered fee structure and at least one incentive is included in at least one of the at least one server and the at least one client.

2. The web-based plurality of operably coupled computers of claim 1, wherein the healthcare image processing applications further comprise:
a neuro-degenerative disease severity indexing application that references a disease severity knowledgebase.

3. The web-based plurality of operably coupled computers of claim 1, wherein the tiered fee structure that includes at least one incentive further comprises:
a plurality of billing discounts, each of the billing discounts associated with one of a plurality of customer services.

4. The web-based plurality of operably coupled computers of claim 3, wherein the plurality of billing discounts and the plurality of customer services further comprises:
a maximum discount if a customer provides consultancy with gradually decreasing discounts if the customer provides clinical outcome with data and a lowest discount if the customer provides data alone.

5. The application service provider system of claim 3, wherein the plurality of billing discounts and the plurality of customer services further comprises:
a first billing discount associated with a customer service of providing image data;
a second billing discount associated with a customer service of providing image data and a clinical outcome; and
a third billing discount associated with a customer service of providing consultancy on clinical image analysis.

6. A method of healthcare image processing performed by a first processor, the method comprising:
sending healthcare image data to a second processor without reference to an initiation command received from a human operator or the first processor;
sending to the second processor, service-order requisition data in reference to an account status of the customer describing a first level of service by the second processor;
receiving from the second processor, an indication of availability of data at the second processor;
sending to the second processor, the initiation command for processing data;
receiving from the second processor, results of the service-order based structured processing applications on the healthcare image data by the second processor;
creating a report in reference to the healthcare image data and in reference to the results; and
receiving from the second processor, an invoice in accordance with the first level of service.

7. The method of claim 6, wherein the service-order based structured application further comprises:
a neuro-degenerative disease severity indexing application that references a disease severity knowledgebase.

8. A method of healthcare image processing performed by a first processor, the method comprising:
sending healthcare image data to a second processor;
sending to the second processor, service-order requisition data in reference to an account status of the customer selecting a second level of service by the second processor and selecting a method of communication for results;
receiving from the second processor through the method of communication, results of the service-order based automated structured processing applications on the healthcare image data by the second processor;
receiving from the second processor through the method of communication, a report in reference to the healthcare image data and in reference to the results; and
receiving from the second processor, an invoice in accordance with the second level of service.

9. The method of claim 8, wherein the service-order based automated structured application further comprises:
a neuro-degenerative disease severity indexing application that references a disease severity knowledgebase.

10. The method of claim 8, wherein the method of communication further comprises one of:
email, DICOM SR, fax, page, and WiFi to wireless.

11. A method of healthcare image processing performed by a first processor, the method comprising:
sending healthcare image data to a second processor;
sending to the second processor, service-order requisition data in reference to an account status of the customer selecting a second level of service that requires technician supervision of processing by the second processor and selecting a method of communication for results;
receiving from the second processor through the method of communication, results of the service-order based structured processing applications supervised by technician on the healthcare image by the second processor;
receiving from the second processor through the method of communication, a report in reference to the healthcare image data and in reference to the results; and
receiving from the second processor, an invoice in accordance with the second level of service.

12. The method of claim 11, wherein the method of communication further comprises one of:
email, DICOM SR, fax, page, and WiFi to wireless.

13. A method of healthcare image processing performed by a first processor, the method comprising:
sending healthcare image data to a second processor;
sending to the second processor, service-order requisition data in reference to an account status of the customer selecting a third level of service that requires expert supervision of processing by the second processor and selecting a method of communication for results;
receiving from the second processor through the method of communication, results of the service-order based structured processing applications supervised by an expert on the healthcare image data by the second processor;
receiving from the second processor through the method of communication, a report in reference to the healthcare image data and in reference to the results; and
receiving from the second processor, an invoice in accordance with the third level of service.

14. The method of claim 13, wherein the method of communication further comprises one of:
email, DICOM SR, fax, page, and WiFi to wireless.

15. A method of healthcare image processing performed by a first processor, the method comprising:
sending healthcare image data to a second processor;
sending to the second processor, service-order requisition data in reference to an account status of the customer selecting a fourth level of service that requires a first expert supervision of processing by the second processor and a second expert collaboration on processed results and selecting a method of communication for results;
receiving from the second processor through the method of communication, results of the service-order based structured processing applications supervised by a first expert on the healthcare image by the second processor;
receiving from the second processor through the method of communication, a report in reference to the healthcare image data and in reference to the results;
receiving from the second processor an on-line collaboration with the second expert through a third processor; and
receiving from the second processor, an invoice in accordance with the fourth level of service.

16. The method of claim 15, wherein the method of communication further comprises one of:
email, DICOM SR, fax, page, and WiFi to wireless.

17. A system that supports collaboration between a customer and a healthcare expert, the system comprising:
a secure server component to moderate the exchange between the customer and the healthcare expert using a structured processing application component;
a secure-communication component operable to communicate with the customer and the healthcare expert; and
a collaborative component operable to exchange data between the customer and the healthcare expert through the secure-communication component, the exchange consisting essentially of between the customer and the healthcare expert.

18. The system of claim 17, wherein the data further comprises:
healthcare image data received from the customer; and
results of neuro-degenerative disease severity index processing of the healthcare image data.

19. An application service provider system that supports collaboration between a customer, a vendor and a healthcare expert, the application service provider system comprising:
a customer secure-communication component operable to communicate with the customer;
a vendor secure-communication component operable to communicate with a vendor;
an expert secure-communication component operable to communicate with a healthcare domain expert, the healthcare domain expert being a clinical luminary having in-depth knowledge in interpreting results generated by a healthcare application, the healthcare application including a healthcare image post-processing software operable to analyze image data for a specific clinical healthcare need; and
a transactional component operable to exchange data between the secure-communication components.

20. The application service provider system of claim 19, wherein the healthcare image post-processing software operable to analyze image data for a specific clinical healthcare need further comprises:
a neuro-degenerative disease severity indexing application.

21. The application service provider system of claim 19, wherein the customer secure-communication component, the vendor secure-communication component and the expert secure-communication component are comprised of a singular secure-communication component.

22. A web-based plurality of operably coupled computers comprising:
at least one server, having healthcare image processing applications;
at least one computer operably coupled to the at least one server and operated by an expert of medical services; and
at least one computer operably coupled to the at least one server and operated by a customer of the medical services,
wherein a data structure identifying a tiered fee structure and at least one incentive is transmitted through the at least one server from the at least one computer that is operated by the expert of medical services to the least one computer operated by the customer of the medical services.

23. The web-based plurality of operably coupled computers of claim 22, wherein the healthcare image processing applications further comprise:
a neuro-degenerative disease severity indexing application that references a disease severity knowledgebase.

24. The web-based plurality of operably coupled computers of claim 22, wherein the tiered fee structure that includes at least one incentive further comprises:
a plurality of billing discounts, each of the billing discounts associated with one of a plurality of customer services.

25. A client of a network application framework system, the client comprising:
a secure-communication component;
a client component operable to send healthcare data to a server through the secure-communication component and the client component further operable to receive processing application results from the server through the secure-communication component;
a graphical user-interface component operable to present the results received from the server;
an expert interface component further operable to receive healthcare recommendations; and
a component operable to receive at least one incentive through the secure-communication component.

26. The client of claim 25 wherein the at least one incentive further comprises:
a maximum discount if a customer operating the client provides consultancy, and the at least one incentive further comprises gradually decreasing discounts if the customer provides clinical outcome with the healthcare data, and the at least one incentive further comprises a lowest discount if the customer provides healthcare data alone.

27. The client of claim 25 wherein the processing application further comprises:
one of an image processing application and a medical image processing application and a structured medical processing application.

28. A client of a network application framework system, the client comprising:
a secure-communication component;
a client component operable to send healthcare data to a server through the secure-communication component and the client component further operable to receive results from the server through the secure-communication component;
a graphical user-interface component operable to present the results received from the server;
an expert interface component further operable to receive recommendations; and
a collaboration component operable to facilitate collaboration in clarification of the results.

29. The client of the network application framework system of claim 28 further comprising a transactional component further is further operable to receive a tiered fee structure that includes at least one incentive, the tiered fee structure further comprising:
a plurality of billing discounts, each of the billing discounts associated with one of a plurality of customer services.

30. The client of the network application framework system of claim 29, wherein the plurality of billing discounts and the plurality of customer services further comprises:
a maximum discount if a customer provides consultancy with gradually decreasing discounts if the customer provides clinical outcome with data and a lowest discount if the customer provides data alone.

31. The client of the network application framework system of claim 28, wherein the plurality of billing discounts and the plurality of customer services further comprises:
a first billing discount associated with a customer service of providing image data;
a second billing discount associated with a customer service of providing image data and a clinical outcome; and
a third billing discount associated with a customer service of providing consultancy on clinical image analysis.

32. A computer of a network application framework system, the computer comprising:
a secure-communication component;
a component operable to receive healthcare imaging data from a server through the secure-communication component;
a graphical user-interface component operable to present the healthcare imaging data received from the server;
an expert interface component further operable to receive recommendations from an operator of the computer; and
a collaboration component operable to facilitate collaboration in clarification of results of healthcare image processing of the data.

33. The computer of claim 32 further comprising a healthcare image processing application that is further comprised of:
one of a healthcare image processing application and a structured healthcare processing application.

34. The computer of claim 33, wherein the structured healthcare processing application further comprises:
a neuro-degenerative disease severity indexing application that references a disease severity knowledgebase.

35. A network application framework system comprising a client and a server, the client further comprising:
a secure-communication component;
a client component operable to send data to the server through the client secure-communication component and the client component further operable to receive results from the server through the client secure-communication component;
an expert interface component operable to present the results received from the server, and the expert interface component further operable to receive recommendations; and
a client collaboration component operable to facilitate collaboration in clarification of the results and the recommendations, and the server further comprising:
a secure-communication component;
a server component operable to receive the data from the client through the secure-communication component;
a healthcare application component operable to process the data and operable to generate the results;
the server component further operable to send the results to the client through the server secure-communication component; and
a collaboration component operable to facilitate collaboration in clarification of the results.

36. The network application framework system of claim 35, wherein the healthcare application component further comprises:
a neuro-degenerative disease severity indexing application that references a disease severity knowledgebase.

37. A network application framework system comprising a client, a server and a computer for an expert:
the client further comprising:
a secure-communication component;
a client component operable to send healthcare data to the server through the client secure-communication component and the client component further operable to receive results from the server through the client secure-communication component;
a expert interface component operable to present the results received from the server, and the expert interface component further operable to receive recommendations; and
a client collaboration component operable to facilitate collaboration in clarification of the results and the recommendations,
the server further comprising:
a secure-communication component;
a server component operable to receive the healthcare data from the client through the secure-communication component;
a healthcare application component operable to process the healthcare data and operable to generate the results;
the server component further operable to send the results to the client through the server secure-communication component; and
a collaboration component operable to facilitate collaboration in clarification of the results, and
the expert computer further comprising:
a secure-communication component;
a component operable to visually present the healthcare data to a user;
a component operable to communicate recommendations from an operator of the expert computer; and
a component operable to send the recommendations through the secure-communication component.

38. The network application framework system of claim 37, wherein the healthcare application component further comprises:
a neuro-degenerative disease severity indexing application that references a disease severity knowledgebase.

39. A web-based plurality of operably coupled computers comprising:
at least one server, having healthcare image processing applications;
at least one computer operably coupled to the at least one server and operated by a vendor of medical services; and
at least one computer operably coupled to the at least one server and operated by an expert of the medical services,
wherein a data structure identifying at least one expert recommendation is transmitted from the at least one computer that is operated by the expert of medical services to the at least one server, and then the data structure transmitted from the at least one server to the least one computer operated by the vendor of the medical services.

40. The web-based plurality of operably coupled computers of claim 39, wherein the healthcare image processing applications further comprise:
a neuro-degenerative disease severity indexing application that references a disease severity knowledgebase.

41. A network application framework system comprising a client and a server:
the client further comprising:
a secure-communication component;
a client component operable to send data to the server through the secure-communication component and the client component further operable to receive results from the server through the secure-communication component;
an expert interface component operable to present the results received from the server, and the expert interface component further operable to receive recommendations; and
a client transactional component operable to receive at least one incentive to an entity that operates the client, and
the server further comprising:
a secure-communication component;
a server component operable to receive the data from the client through the secure-communication component;
a healthcare application component operable to process the data and operable to generate the results;
the server component further operable to send the results to the client through the secure-communication component; and
a transactional component operable to provide a tiered fee structure that includes at least one incentive.

42. The network application framework system of claim 41, wherein the tiered fee structure that includes at least one incentive further comprises:
a plurality of billing discounts, each of the billing discounts associated with one of a plurality of customer services.

43. The network application framework system of claim 42, wherein the plurality of billing discounts and the plurality of customer services further comprises:
a maximum discount if a customer provides consultancy with gradually decreasing discounts if the customer provides clinical outcome with data and a lowest discount if the customer provides data alone.

44. The network application framework system of claim 42, wherein the plurality of billing discounts and the plurality of customer services further comprises:
a first billing discount associated with a customer service of providing image data;
a second billing discount associated with a customer service of providing image data and a clinical outcome; and
a third billing discount associated with a customer service of providing consultancy on clinical image analysis.

45. The network application framework system of claim 44 wherein the data is one of image data and medical image data and structured medical data and structured medical image data.

46. A client of a network application framework system, the client comprising:
a secure-communication component;
a client component operable to send healthcare data to a server through the secure-communication component and the client component further operable to receive results from the server through the secure-communication component;
a graphical user-interface component operable to present the results received from the server, and the expert interface component further operable to receive recommendations; and
a component operable to receive a plurality of incentives for expert advice to an entity that operates the client.

47. The client in claim 46 wherein the healthcare data is one of healthcare image data and healthcare image data and structured healthcare data and structured healthcare image data

48. The client of claim 46, wherein the plurality of incentives further comprise:
a plurality of billing discounts, each of the billing discounts associated with one of a plurality of customer services.

49. The client of claim 48, wherein the plurality of billing discounts and the plurality of customer services further comprises:
a maximum discount if a customer provides consultancy with gradually decreasing discounts if the customer provides clinical outcome with data and a lowest discount if the customer provides data alone.

50. The network application framework system of claim 48, wherein the plurality of billing discounts and the plurality of customer services further comprises:
a first billing discount associated with a customer service of providing image data;
a second billing discount associated with a customer service of providing image data and a clinical outcome; and
a third billing discount associated with a customer service of providing consultancy on clinical image analysis.

51. A network application framework system comprising a client and a server,
the client further comprising:
a secure-communication component;
a client component operable to send data to the server through the secure-communication component and the client component further operable to receive results from the server through the secure-communication component;
an expert interface component operable to present the results received from the server, and the expert interface component further operable to provide recommendations; and
a client transactional component operable to receive a plurality of incentives for expert advice to an entity that operates the server; and
the server further comprising:
a secure-communication component;
a server component operable to receive the data from the client through the secure-communication component;
a healthcare application component operable to process the data and operable to generate the results;
the server component further operable to send the results to the client through the server secure-communication component; and
a transactional component operable to provide the plurality of incentives.

52. The network application framework system of claim 51, wherein the plurality of incentives further comprises:
a plurality of billing discounts, each of the billing discounts associated with one of a plurality of customer services.

53. The network application framework system of claim 52, wherein the plurality of billing discounts and the plurality of customer services further comprises:
a maximum discount if a customer provides consultancy with gradually decreasing discounts if the customer provides clinical outcome with data and a lowest discount if the customer provides data alone.

54. The network application framework system of claim 53, wherein the plurality of billing discounts and the plurality of customer services further comprises:
a first billing discount associated with a customer service of providing image data;
a second billing discount associated with a customer service of providing image data and a clinical outcome; and
a third billing discount associated with a customer service of providing consultancy on clinical image analysis.

55. The network application framework system of claim 54, wherein the first billing discount further comprises a 10% billing discount; the second billing discount further comprises a 20% billing discount and; the third billing discount further comprises a 50% billing discount.

56. A method to support collaboration between a customer, a healthcare vendor and a healthcare-expert, the method comprising:
receiving healthcare-expert service-order requisition data in reference to an account status of the customer, wherein the account status includes a plurality of billing discounts and a plurality of customer services further comprises:
a first billing discount associated with a customer service of providing image data,
a second billing discount associated with a customer service of providing image data and a clinical outcome, and
a third billing discount associated with a customer service of providing consultancy on clinical image analysis; and
sending the healthcare service order requisition data to a vendor.

57. A method to support between a healthcare vendor and a healthcare-expert, the method comprising:
receiving an order with data from a client regarding healthcare-expert service-order requisition;
presenting the result to the healthcare-expert;
receiving a response from the healthcare-expert; and
sending the response to the healthcare vendor.

58. A web-based plurality of operably coupled computers comprising:
at least one server, having healthcare image processing applications;
at least one computer operably coupled to the at least one server and operated by a vendor of medical services;
at least one computer operably coupled to the at least one server and operated by a customer of the medical services; and
at least one computer operably coupled to the at least one server and operated by a expert of the medical services,
wherein a data structure identifying at least one expert recommendation is transmitted from the at least one computer that is operated by the expert of medical services to the at least one server, and then the data structure transmitted from the at least one server to the least one computer operated by the vendor of the medical services,
wherein a data structure identifying a tiered fee structure and at least one incentive is transmitted through the at least one server from the at least one computer that is operated by the vendor of medical services to the least one computer operated by the customer of the medical services.

59. The web-based plurality of operably coupled computers of claim 58, wherein the healthcare image processing applications further comprise:
a neuro-degenerative disease severity indexing application that references a disease severity knowledgebase.

60. The web-based plurality of operably coupled computers of claim 58, wherein the tiered fee structure that includes at least one incentive further comprises:
a plurality of billing discounts, each of the billing discounts associated with one of a plurality of customer services.

61. A method to support collaboration between a customer, a healthcare vendor and a healthcare-expert, the method comprising:
transmitting an order-requisition-form to an entity selected from a group consisting of a human, a computer, a human technician and a human expert; the sending being performed by an entity selected from a group consisting of the human and the computer;
providing a healthcare image processing application in accordance with the order-requisition-form, the healthcare image processing application being performed by an entity selected from the group consisting of the human, the computer, the human technician and the human expert;
analyzing results of the processing of the healthcare image processing application in accordance with the order-requisition-form, the analyzing being performed by an entity selected from a group consisting of the human, the computer, the human expert and a human collaborator; and
reporting results of the analyzing, the reporting being performed by the entity selected from the group consisting of the human, the computer, the human expert and the human collaborator.

62. The method of claim 61, wherein the healthcare image processing application further comprises:
a neuro-degenerative disease severity indexing application that references a disease severity knowledgebase.

63. The method of claim 61, further comprising:
providing a tiered fee structure that includes at least one incentive.

64. The method of claim 63, wherein the tiered fee structure that includes at least one incentive further comprises:
a plurality of billing discounts, each of the billing discounts associated with one of a plurality of customer services.

65. An application service provider system comprising:
a secure-communication component operable to communicate with a customer;
an application component operable to receive an order-requisition-form from the customer through the secure-communication component and operable to perform a healthcare application in reference to the order-requisition-form to provide results to the customer; and
a transactional component operable to provide a tiered fee structure that includes at least one incentive.

66. The application service provider system of claim 65, wherein the tiered fee structure that includes at least one incentive further comprises:
a plurality of billing discounts, each of the billing discounts associated with one of a plurality of customer services.

67. The application service provider system of claim 66, wherein the plurality of billing discounts and the plurality of customer services further comprises:
a maximum discount if a customer provides consultancy with gradually decreasing discounts if the customer provides clinical outcome with data and a lowest discount if the customer provides data alone.

68. The application service provider system of claim 67, wherein the plurality of billing discounts and the plurality of customer services further comprises:
a first billing discount associated with a customer service of providing image data;
a second billing discount associated with a customer service of providing image data and a clinical outcome; and
a third billing discount associated with a customer service of providing consultancy on clinical image analysis.

69. The application service provider system of claim 65 further comprising:
a transactional component operable to provide a plurality of incentives for expert advice to an entity that operates the application service provider system.

70. The application service provider system of claim 65 further comprising:
a collaboration component operable to facilitate collaboration in clarification of the results.

71. The application service provider system of claim 65 further comprising:
an administrative component operable to route the order requisition form and operable to schedule personnel in reference to tasks of the order requisition form.

72. The application service provider system of claim 65, wherein the healthcare application further comprises:
one of an image processing application and a medical image processing application and a structured medical processing application.

73. A server of a network application framework system, the server comprising:
a secure-communication component;
a server component operable to receive data from a client through the secure-communication component; and
a healthcare application component operable to process the data and operable to generate results;
the server component further operable to send the results to the client through the secure-communication component;
a transactional component operable to provide a tiered fee structure that includes at least one incentive.

74. The server of claim 73 wherein the data to be processed is one of image data and medical image data.

75. The server of the network application framework system of claim 73, the healthcare application component further comprising:
post-processing software operable to analyze image data for a specific clinical need.

76. The server of claim 73, wherein the tiered fee structure that includes at least one incentive further comprises:
a plurality of billing discounts, each of the billing discounts associated with one of a plurality of customer services.

77. The server of claim 76, wherein the plurality of billing discounts and the plurality of customer services further comprises:
a maximum discount if a customer provides consultancy with gradually decreasing discounts if the customer provides clinical outcome with data and a lowest discount if the customer provides data alone.

78. The application service provider system of claim 76, wherein the plurality of billing discounts and the plurality of customer services further comprises:
a first billing discount associated with a customer service of providing image data;
a second billing discount associated with a customer service of providing image data and a clinical outcome; and
a third billing discount associated with a customer service of providing consultancy on clinical image analysis.

79. A server of a network application framework system, the server comprising:
a secure-communication component;
a server component operable to receive data from a client through the secure-communication component;
a healthcare application component operable to process the data and operable to generate results;
the server component further operable to send the results to the client through the secure-communication component;
a transactional component operable to provide a plurality of incentive driven data.

80. The server of claim 79 wherein the incentive driven data is one of data, data plus outcome and data plus outcome plus consultancy.

81. The server of claim 80 wherein the incentive driven further comprises:
a plurality of billing discounts, each of the billing discounts associated with one of a plurality of customer services.

82. The network application framework system of claim 81, wherein the plurality of billing discounts and the plurality of customer services further comprises:
a maximum discount if a customer provides consultancy with gradually decreasing discounts if the customer provides clinical outcome with data and a lowest discount if the customer provides data alone.

83. The network application framework system of claim 81, wherein the plurality of billing discounts and the plurality of customer services further comprises:
a first billing discount associated with a customer service of providing image data;
a second billing discount associated with a customer service of providing image data and a clinical outcome; and
a third billing discount associated with a customer service of providing consultancy on clinical image analysis.

84. A server of a network application framework system, the server comprising:
a secure-communication component;
a server component operable to receive data from a client through the secure-communication component;
a healthcare application component operable to process the data and operable to generate results;
the server component further operable to send the results to the client through the secure-communication component; and
a collaboration component operable to facilitate collaboration in clarification of the results.

85. An apparatus comprising:
a processing algorithm component;
reference data accessible to the processing algorithm component;
a disease severity knowledgebase accessible to the processing algorithm component;
a secure-communication layer operably coupled to the processing algorithm component;
an administration layer operably coupled to the processing algorithm component;
an Internet access component further comprising a graphical user interface, the Internet access component operably coupled to the processing algorithm component.

86. The apparatus of claim 85 wherein the processing algorithm component further comprises at least one of:
a 3D-SSP processing algorithm component;
a SPM processing algorithm component; and
a AMI processing algorithm component.

87. The apparatus of claim 85 wherein the reference data further comprises at least one of:
normalized reference data with reference to at least one tracer;
age-segregated reference data; and
reference data segregated with reference to non-age criteria.

88. The apparatus of claim 85 wherein the secure-communication layer further comprises at least one of:
a DICOM secure-communication layer; and
a web-based secure-communication layer.

89. The apparatus of claim 85 wherein the administration layer further comprises at least one of:
an account management administration layer;
an access control administration layer;
a security administration layer; and
a scheduling administration layer.

90. The apparatus of claim 85 wherein the Internet access component further comprises at least one of:
an application Internet access component; and
an infrastructure Internet access component.

91. A method to support collaboration between a customer, a healthcare vendor and a healthcare-expert, the method comprising:
receiving healthcare-expert service-order requisition data in reference to an account status of the customer;
routing the healthcare-expert service-order requisition data to an appropriate healthcare application;
scheduling personnel in reference to the healthcare-expert service-order requisition data;
receiving a result from the appropriate healthcare application;
sending the result to the healthcare-expert; and
receiving a response from the healthcare-expert.

92. The method of claim 91, wherein the appropriate healthcare application further comprises:
a neuro-degenerative disease severity indexing application.

93. A method of healthcare image processing performed by a first processor, the method comprising:
sending healthcare image data to a second processor in reference to an initiation command received from a human operator or the first processor;
sending to the second processor, service-order requisition data in reference to an account status of the customer describing a first level of service by the second processor;
receiving from the second processor, results of the service-order based structured processing applications on the healthcare image data by the second processor;
creating a report in reference to the healthcare image data and in reference to the results; and
receiving from the second processor, an invoice in accordance with the first level of service.

94. The method of claim 93, wherein the service-order based structured application further comprises:
a neuro-degenerative disease severity indexing application that references a disease severity knowledgebase.
